(19) United States
(12) Patent Application Publication
(10) Pub. No.: US 2010/0066749 A1
(43) Pub. Date: Mar. 18, 2010

(54) IMAGE FORMING APPARATUS WITH SOFTWARE COMPONENTS

(75) Inventors: Akihiro Mihara, Kanagawa (JP); Jun Kawada, Kanagawa (JP); Yoshinaga Kato, Kanagawa (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/554,021

(22) Filed: Sep. 4, 2009

(30) Foreign Application Priority Data
Sep. 17, 2008 (JP) 2008-238629

(51) Int. Cl. G06T 1/00

(52) U.S. Cl. 345/522

(57) ABSTRACT

An image forming apparatus includes an embed-information processing control unit configured to control, based on a first software component, embed-information processing for extracting embedded information or for embedding information with respect to image data output from a second software component, and an embed-information processing service unit configured to perform the embed-information processing with respect to the image data in response to an instruction from the embed-information processing control unit, wherein the embed-information processing service unit includes a shared service unit configured to perform a process shared by different types of the embed-information processing, and one or more specific service units each configured to perform a different process specific to a different type of the embed-information processing, and wherein the shared service unit receives an instruction from the embed-information processing control unit, and the specific service units perform the embed-information processing with respect to the image data.

### BACKGROUND OF THE INVENTION

1. Field of the Invention

The disclosures herein generally relate to an image forming apparatus, and particularly relate to an image forming apparatus that has a software component connected thereto to perform a process constituting part of a job relating to image data.

2. Description of the Related Art

Japanese Patent Application Publication No. 2007-325251 (hereinafter referred to as Patent Document 1) discloses an image forming apparatus that employs a pipe-&-filter architecture to use a software component called an activity, which is comprised of combined software components referred to as filters, thereby implementing an application for performing a job. Such an image forming apparatus can simplify tasks that are to be performed to customize or extend functions.

There are some image forming apparatuses that are provided with the functions to extract information embedded in scanned document images and to analyze the information regarding the documents (see, for example, Japanese Patent Application Publication No. 2006-20258, which will be hereinafter referred to as Patent Document 2). Such functions may include a marking detecting function to detect the tampering of documents or to track the distribution routes of documents (i.e., to detect a person who printed the documents).

As described above, an image forming apparatus disclosed in Patent Document 1 is provided with the marking detecting function. Such a marking detection function may be implemented by use of a filter (which will be hereinafter referred to as a marking detection filter) configured to extract information from an image input through an input filter, to perform analysis, and to output the results of the analysis. The detection of tampering and the detection of a person who has printed the document require different information extraction processes, different analysis processes, and different formats for outputting analysis results. Accordingly, different marking detection filters may need to be created according to varying usages of information embedded in document images. When both the function to detect tampering and the function to detect a person who has printed the document are to be implemented, different marking detection filters (e.g., a tampering detection filter and a print-person detection filter) may need to be created to satisfy the varying needs.

An activity may be created for each different combination of an input filter and a marking detection filter. For example, a tampering detection activity that utilizes a tampering detection filter and a print-person detection activity that utilizes a print-person detection filter may be created.

The task to develop these filters and activities may be simple as far as the technologies preceding the technology disclosed in Patent Document 1 are concerned. When considering the fact that there are many parts shared by different marking filters and different activities utilizing these marking filters, however, there may be a need to further improve customizability.

Accordingly, it may be desirable to provide an image forming apparatus that can improve the customizability of functions that process information embedded in images.

### SUMMARY OF THE INVENTION

In one embodiment, an image forming apparatus for performing a job relating to image data, to which software components are connected to perform processes constituting respective parts of the job, includes: an embed-information processing control unit configured to control, based on a first one of the software components, embed-information processing for extracting embedded information or for embedding information with respect to image data output from a second one of the software components; and an embed-information processing service unit configured to perform the embed-information processing with respect to the image data in response to an instruction from the embed-information processing control unit, wherein the embed-information processing service unit includes a shared service unit configured to perform a process shared by different types of the embed-information processing, and one or more specific service units each configured to perform a different process specific to a different type of the embed-information processing, and wherein the shared service unit is configured to receive an instruction from the embed-information processing control unit, and the specific service units are configured to perform the embed-information processing with respect to the image data.

In another embodiment, a method of performing a job relating to image data in an image forming apparatus to which software components are connected to perform processes constituting respective parts of the job includes: controlling, based on a first one of the software components, embed-information processing for extracting embedded information or for embedding information with respect to image data output from a second one of the software components; and performing the embed-information processing with respect to the image data in response to an instruction from the step of controlling, wherein the step of performing includes utilizing a shared service unit configured to perform a process shared by different types of the embed-information processing, and utilizing one or more specific service units each configured to perform a different process specific to a different type of the embed-information processing, and wherein the shared service unit is configured to receive an instruction from the embed-information processing control unit, and the specific service units are configured to perform the embed-information processing with respect to the image data.

According to at least one embodiment, an image forming apparatus can improve the customizability of functions that process information embedded in images.

### BRIEF DESCRIPTION OF THE DRAWINGS

Other objects and further features of embodiments will be apparent from the following detailed description when read in conjunction with the accompanying drawings, in which:

FIG. 1 is a drawing showing an example of the hardware configuration of an image forming apparatus according to an embodiment;

FIG. 2 is a drawing showing an example of the software configuration of the image forming apparatus according to the present embodiment;

FIG. 3 is a drawing for explaining the basic principle of a pipe-and-filter architecture;

FIG. 4 is a drawing illustrating examples of filter combinations for implementing various functions provided in the multifunctional machine of the present embodiment;

FIG. 5 is a drawing illustrating the constituent elements of a filter;

FIG. 6 is a drawing illustrating the constituent elements of an activity;

FIG. 7 is a drawing showing an example of the configuration of software components for implementing a marking function;

FIG. 8 is a drawing showing an example of the configuration of a marking activity, a marking filter, and a marking service;

FIG. 9 is a drawing showing an example of a configuration in which a print-person detection function and a tampering detection function are implemented with respect to a marking framework;

FIG. 10 is a drawing showing an example of the configuration of a marking service shared unit;

FIG. 11 is a drawing illustrating the outline of an initialization process performed for a marking job;

FIG. 12 is a sequence chart illustrating an initialization process performed for a marking job;

FIG. 13 is a sequence chart illustrating an initialization process performed for a marking job;

FIG. 14 is a drawing illustrating an example of a display item definition table;

FIG. 15 is a drawing illustrating the way a scan filter preference and a marking filter preference are connected together;

FIG. 16 is a drawing illustrating the way a scan filter preference, a marking filter preference, and a print filter preference are connected together;

FIG. 17 is a sequence chart illustrating the setting of configuration information about marking attributes with respect to a marking service preference;

FIG. 18 is a sequence chart illustrating the setting of initial values of marking attributes with respect to a marking service preference;

FIG. 19 is a drawing showing an example of a login screen;

FIG. 20 is a drawing illustrating an example of a user authority table;

FIG. 21 is a drawing showing an example of an application selection screen;

FIG. 22 is a drawing showing an example of a print-person detection setting screen;

FIG. 23 is a drawing showing an example of a tampering detection setting screen;

FIG. 24 is a drawing illustrating an outline of the process of setting attribute values with respect to a marking job;

FIG. 25 is a sequence chart illustrating the process of setting attribute values with respect to a marking job;

FIG. 26 is a sequence chart illustrating the process of performing a marking job;

FIG. 27 is a sequence chart illustrating the process of performing a marking job;

FIG. 28 is a drawing illustrating an example of a job tree obtained in the case of a print-person detection job;

FIG. 29 is a drawing illustrating an example of a job tree obtained in the case of a tampering detection job;

FIG. 30 is a drawing illustrating inter-filter adjustment;

FIG. 31 is a drawing illustrating an outline of the procedure of a marking job;

FIG. 32 is a sequence chart illustrating the process of acquiring an image type processable by a marking service;

FIG. 33 is a sequence chart illustrating the process of generating service providing conditions by the marking service;

FIG. 34 is a drawing illustrating the relationships between a service providing condition, a marking service specific unit, and marking attributes;

FIG. 35 is a sequence chart illustrating marking performed by the marking service;

FIG. 36 is a sequence chart illustrating the process of ending marking performed by the marking service;

FIG. 37 is a sequence chart illustrating the process of aborting marking performed by the marking service;

FIG. 38 is a sequence diagram illustrating processes performed when a detection completion event is reported from the marking service;

FIG. 39 is a sequence diagram illustrating processes performed when a detection completion event is reported from the marking service;

FIG. 40 is a drawing illustrating an example of a print-person detection result screen;

FIG. 41 is a drawing showing an example of a tampering detection setting screen;

FIG. 42 is a sequence diagram illustrating processes performed when a termination completion event or abortion completion event is reported from the marking service;

FIG. 43 is a drawing illustrating an example of a configuration in which a marking framework does not have a marking service shared unit; and

FIG. 44 is a drawing illustrating an example of a configuration in which a marking framework does not have a marking activity shared unit.

### DESCRIPTION OF THE PREFERRED EMBODIMENTS

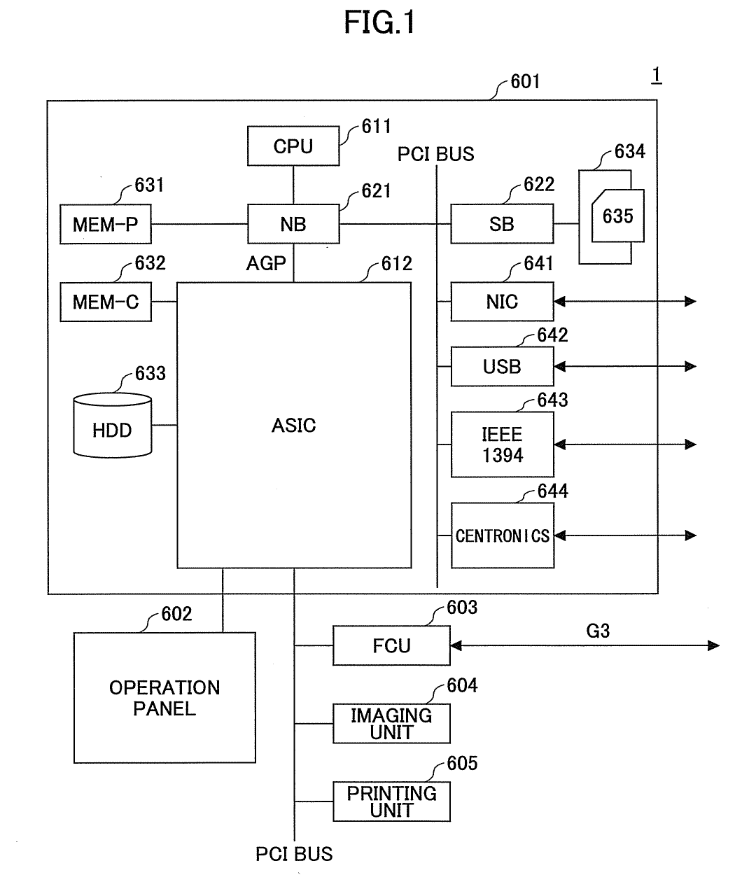

In the following, embodiments of the present invention will be described with reference to the accompanying drawings. These embodiments will be described by using an image forming apparatus as an example of an information processing apparatus. FIG. 1 is a drawing showing an example of the hardware configuration of an image forming apparatus according to an embodiment. As an example of an image forming apparatus, FIG. 1 illustrates the hardware configuration of a multifunctional machine 1 that provides plural functions such as a printer function, a copy function, a scanner function, and a facsimile function.

The hardware of the multifunctional machine 1 includes a controller 601, an operation panel 602, a facsimile control unit (FCU) 603, an imaging unit 604, and a printing unit 605.

The controller 601 includes a CPU 611, an ASIC 612, an NB 621, an SB 622, an MEM-P 631, an MEM-C 632, an HDD (hard-disk drive) 633, a memory card slot 634, an NIC (network interface controller) 641, a USB device 642, an IEEE 1394 device 643, and a Centronics device 644.

The CPU 611 is an IC for performing various types of information processing. The ASIC 612 is an IC for performing various types of image processing. The NB 621 is a north bridge of the controller 601. The SB 622 is a south bridge of the controller 601. The MEM-P 631 is a system memory of the multifunctional machine 1. The MEN-C 632 is a local memory of the multifunctional machine 1. The HDD 633 is a storage unit of the multifunctional machine 1. The memory card slot 634 is a slot that receives a memory card 635. The NIC 641 is a controller for network communication based on the MAC address. The USB device 642 serves to provide connection terminals conforming to the USB specification. The IEEE 1394 device 643 serves to provide connection terminals conforming to the IEEE1394 specification. The Centronics device 644 serves to provide connection terminals conforming to the Centronics specification. The operation panel 602 serves as the hardware unit (operation unit) by which the operator enters an input into the multifunctional machine 1, and also serves as the hardware unit (display unit) through which the operator obtains the output of the multifunctional machine 1.

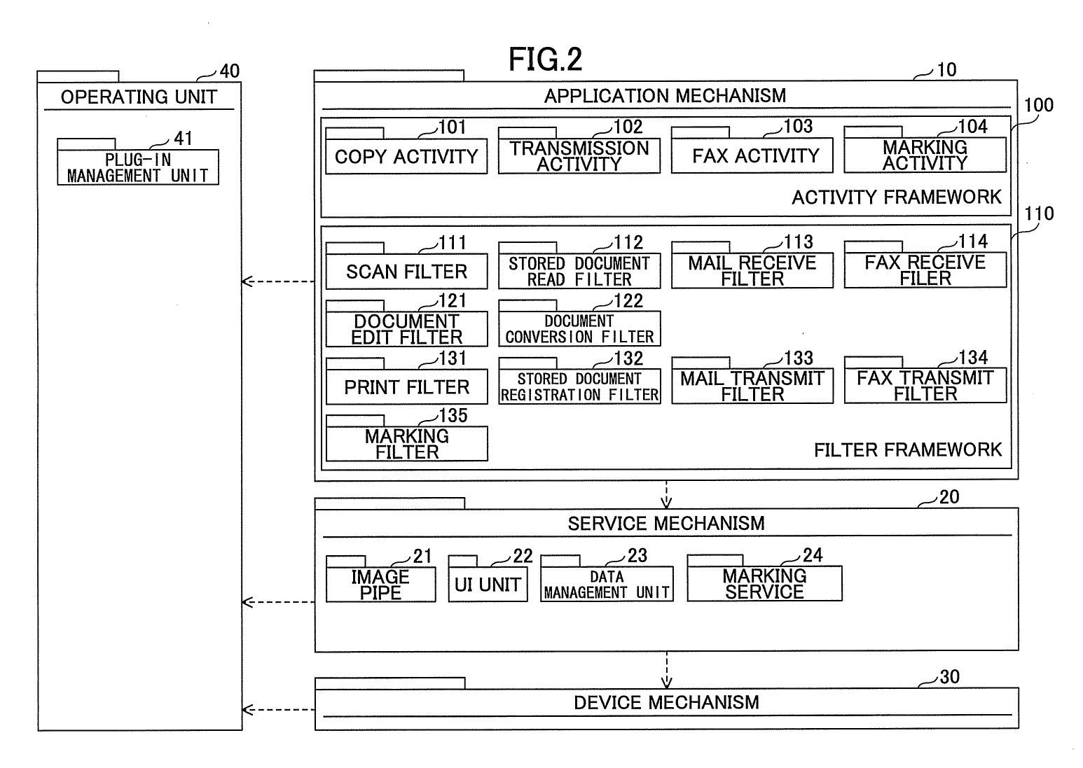

FIG. 2 is a drawing showing an example of the software configuration of the image forming apparatus according to the present embodiment. As illustrated in FIG. 2, the software provided in the multifunctional machine 1 includes layers such as an application mechanism 10, a service mechanism 20, a device mechanism 30, and an operating unit 40. The relationship between an upper layer and a lower layer illustrated in FIG. 2 relate to the relationship between a calling layer and a called layer. Namely, as a general principle, an upper layer calls a lower layer in FIG. 2. The software illustrated in FIG. 2 may be stored in the HDD 633, and is loaded to the MEM-P 631 for execution by the CPU 611 to exert its functions.

The application mechanism 10 is a layer in which a set of software components (i.e., programs) for letting a user utilize the resources of the multifunctional machine 1, e.g., its functions and information (data), are implemented. In the present embodiment, some of the software components implemented in the application mechanism 10 are referred to as “filters”. Such term is used because applications for performing jobs in the multifunctional machine 1 are configured based on a software architecture referred to as “pipe-and-filter”.

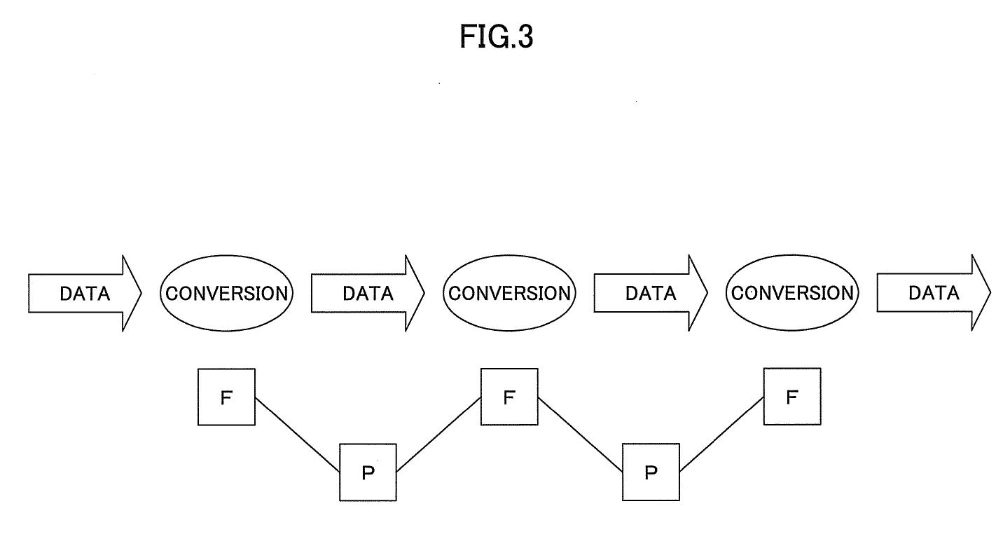

FIG. 3 is a drawing for explaining the basic principle of the pipe-and-filter architecture. In FIG. 3, “F” represents a filter, and “P” represents a pipe. As illustrated, individual filters are connected through pipes. A filter converts its input data, and outputs the result of the conversion. A pipe is implemented as a recording area or the like accessible from filters situated at its opposite ends, respectively, and transmits data output from one of the filters to the other filter.

Namely, the multifunctional machine 1 of the present embodiment treats a job as a series of conversions performed with respect to a document (data). A job in the multifunctional machine 1 may be generalized as being comprised of the inputting, processing, and outputting of a document. Then, “inputting”, “processing”, and “outputting” are each treated as one “conversion”. A software component for implementing one conversion is implemented as a filter. A filter for implementing an inputting operation is referred to as an “input filter”. A filter for implementing a processing operation is referred to as a “processing filter”. A filter for implementing an outputting operation is referred to as an “output filter”. Basically, each filter cannot perform one job by itself. A plurality of filters each performing respective part of a job are connected as illustrated in FIG. 3 to constitute an application that performs one job.

Each filter is implemented as being operable on a filter framework 110. Specifically, each filter may be provided with an interface that is defined with respect to the filter framework 110. The filter framework 110 controls the operating procedure of each filter through such an interface.

Filters are independent of each other. As a general principle, interdependence (i.e., calling-and-called relationship) is not in existence between the filters. Accordingly, addition (i.e., install) and removal (i.e., uninstall) can be performed on a filter-by-filter basis.

In FIG. 2, the application mechanism 10 includes as input filters a scan filter 111, a stored document read filter 112, a mail receive filter 113, and a fax receive filter 114.

The scan filter 111 controls the scanning of image data by use of the imaging unit (scanner) 604, and outputs the scanned image data. The stored document read filter 112 reads document data (e.g., image data) stored in the memory device of the multifunctional machine 1, and outputs the read image data. The mail receive filter 113 receives electronic mail, and outputs data contained in the electronic mail. The fax receive filter 114 controls facsimile reception, and outputs the received print data.

In FIG. 2, further, a document edit filter 121 and a document conversion filter 122 are illustrated as processing filters. The document edit filter 121 applies a predetermined image conversion process (e.g., size change, rotation, combining, etc.) to input data, and outputs the converted data. The document conversion filter 122 converts data formats of image data. The document conversion filter 122 performs a rendering process, for example, which converts input PostScript data into bitmap data for outputting.

In FIG. 2, further, a print filter 131, a stored document registration filter 132, a mail transmit filter 133, a fax transmit filter 134, and a marking filter 135 are illustrated as output filters.

The print filter 131 uses a plotter to output (i.e., print) supplied data. The stored document registration filter 132 stores supplied data in the memory device of the multifunctional machine 1 such as the HDD 633. The mail transmit filter 133 transmits an electronic mail to which supplied data is attached. The fax transmit filter 134 transmits supplied data as facsimile transmission. The marking filter 135 controls the process of extracting embedded information and/or the process of embedding information with respect to supplied image data, and outputs the result of the processing. Here, the embedded information refers to information embedded in an image in addition to the drawing data of the image by use of a data form such as a background form or a barcode form. The usage of embedded information is not limited to a particular usage. Examples of usages include the detection of tampering of a paper document, the detection of a print person (i.e., print-person detection) that detects a person who has ordered to print or copy a document, and so on.

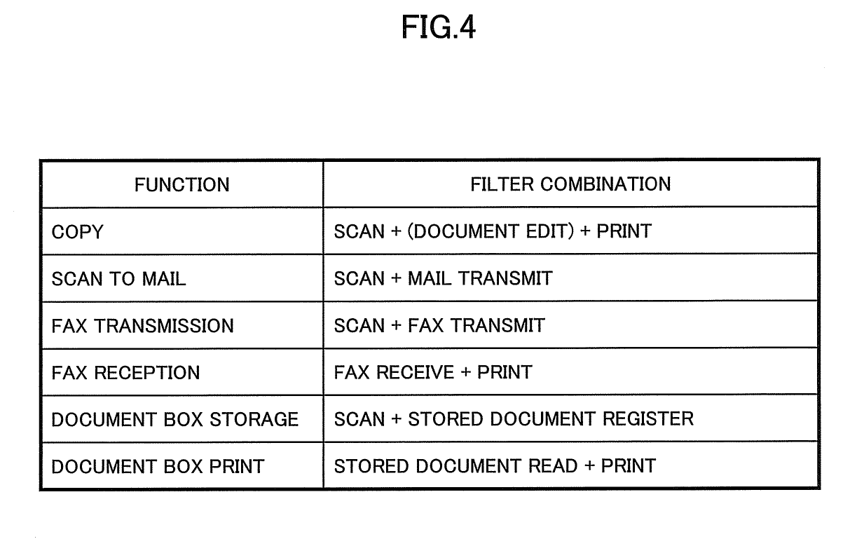

Various types of functions provided in the multifunctional machine 1 may be implemented by use of filter combinations as follows. FIG. 4 is a drawing illustrating examples of filter combinations for implementing various functions provided in the multifunctional machine of the present embodiment.

A copy function may be implemented by connecting the scan filter 111 and the print filter 131. With this configuration, image data scanned by the scan filter 111 from a document sheet is printed by the print filter 131. When processing such as combining, size enlargement, or size reduction is requested, the document edit filter 121 for performing the requested processing is inserted between the two filters.

A scan-to-email function (i.e., the function to transmit scanned image data by electronic mail) may be implemented by connecting the scan filter 111 and the mail transmit filter 133. A fax transmission function may be implemented by connecting the scan filter 111 and the fax transmit filter 134. A fax receive function may be implemented by connecting the fax receive filter 114 and the print filter 131. A document-box storage function (i.e., the function to store scanned image data in the multifunctional machine 1) may be implemented by connecting the scan filter 111 and the stored document registration filter 132. A document-box print function (i.e., the function to print document data stored in the multifunctional machine 1) may be implemented by connecting the stored document read filter 112 and the print filter 131.

In FIG. 4, the scan filter 111, for example, is used in four functions. In this manner, each filter may be usable by a plurality of functions. This fact can be utilized to reduce the number of development stages for implementing these functions. Further, application is implemented by using filters as components in the multifunctional machine 1, so that the customization and extension of functions can be easily achieved. Since there is no functional interdependence between filters, and their independence is maintained, an addition of a new filter and/or modification of filter combinations may be easily made to develop a new application. When it is requested to implement a new application, it may be the case that only a part of the application is not yet implemented. In such a case, a filter for implementing such a part may be developed and installed. With this arrangement, the frequency of modifications required for the implementation of new applications may be reduced with respect to the layers situated lower than the application mechanism 10, thereby providing a firm platform.

In the application mechanism 10, there is a software component referred to as “activity”. The activity is a software component configured to manage what sequence the filters should be arranged and to cause these filters to operate in such a sequence to perform a job. One activity implements one application.

Since filters have strong independence, a filter combination (i.e., connect relationship) can be dynamically configured. Specifically, the filters to be used, the sequence in which the filters operate, and the operating conditions of the filters may be determined by a user using the operation panel 602 each time a request to perform a job is received, thereby providing a function desired by the user.

It may be cumbersome for a user to select filters each time a job is to be performed, especially when the function to be used is a frequently used function such as a copy function. The activity solves such a problem. Namely, a filter combination (i.e., connect relationship) may be defined in advance as an activity. Then, a user can select an activity to perform on an activity-specific basis. The selected activity automatically executes the combination of filters defined in the activity. The use of such an activity can remove trouble associated with the manual operation, and also can provide the feel of operation similar to a conventional user interface by which a job to be performed is selected on an application-by-application basis.

In FIG. 2, examples of activities include a copy activity 101, a transmission activity 102, a fax activity 103, and a marking activity 104. The copy activity 101 may implement a copy job (i.e., copy application) by use of a combination of the scan filter 111, the document edit filter 121, and the print filter 131. The marking activity 104 will be described later.

Each activity is implemented as being operable on an activity framework 100. Specifically, each activity may preferably be provided with an interface that is defined with respect to the activity framework 100. The activity framework 100 controls the operating procedure of each activity through such an interface.

As a general principle, activities are independent of each other, and interdependence (i.e., calling-and-called relationship) is not in existence between the activities. Accordingly, addition (i.e., install) and removal (i.e., uninstall) can be performed on an activity-by-activity basis. In addition to the activities illustrated in FIG. 2, other activities may be created and installed as combinations of various types of filters according to need.

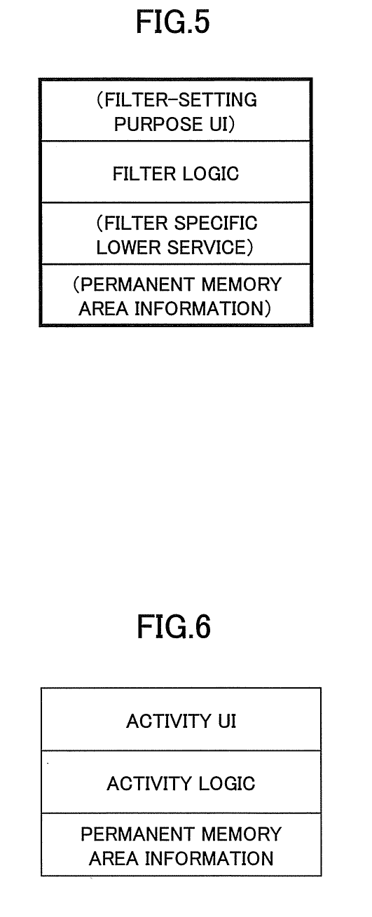

In the following, a description will be given of the filter and the activity in detail. FIG. 5 is a drawing illustrating the constituent elements of a filter. As illustrated in FIG. 5, each filter may include a filter-setting-purpose UI, a filter logic, a filter specific lower-order service, and permanent memory area information. Among these, the filter-setting-purpose UI, the filter specific lower-order service, and the permanent memory area information may not be included as a constituent element in some filters.

The filter-setting-purpose UI is a program that displays a screen for causing filter operating conditions and the like to be set on the operation panel 602. Namely, operating conditions are set separately for each filter. In the case of the scan filter 111; for example, the filter-setting-purpose UI provides a screen for setting a document type, a scan size, resolution, etc. The filter-setting-purpose UI may be HTML data or a script if the operation panel 602 can control display based on HTML data or scripts.

The filter logic is a program implementing a logic for achieving a filter function. Namely, the filter logic provides a filter function in response to the operating conditions set through the filter-setting-purpose UI by use of the filter specific lower-order service provided as a filter constituent element, the service mechanism 20, and the like. In the case of the scan filter 111, for example, the filter logic may correspond to a logic for controlling a document scan performed by the imaging unit 604.

The filter specific lower-order service is a lower-order function(s) (i.e., library) required to implement the filter logic.

The permanent memory area information is a schema definition of data that needs to be stored in a nonvolatile memory such as filter setting information (e.g., default values of operating conditions). The schema definition may be registered in a data management unit 23 at the time of filter installment.

FIG. 6 is a drawing illustrating the constituent elements of an activity. As illustrated in FIG. 6, an activity may include an activity UI, an activity logic, and permanent memory area information.

The activity UI is a program or data used to display an activity-related screen (e.g., a setting screen used to set activity operating conditions and the like) on the operation panel 602.

The activity logic is a program implementing the details of processes of the activity. As a general principle, the activity logic includes a logic regarding a filter combination (e.g., the sequence in which the filters operate, settings shared by two or more filters, modification to filter connections, error handling, etc.).

The permanent memory area information is a schema definition of data that needs to be stored in a nonvolatile memory such as activity setting information (e.g., default values of operating conditions). The schema definition may be registered in the data management unit 23 at the time of activity installment.

Referring to FIG. 2 again, the service mechanism 20 is a layer in which software components for providing primitive services used by activities or filters and software components for providing mechanisms to make applications independent of the hardware specifications of models are implemented. In FIG. 2, the service mechanism 20 includes software components such as an image pipe 21, a UI unit 22, the data management unit 23, and a marking service 24.

The image pipe 21 provides the pipe function as previously described. Namely, the image pipe 21 uses a memory area or the like to transmit the output data of a filter to a next filter. In FIG. 2, the image pipe 21 is illustrated as a single block. In reality, however, the same number of image pipes 21 are provided as there are pipes connecting filters.

The UI unit 22 analyzes a service request supplied through an operating screen displayed on the operation panel 602, and delegates the control of processes responsive to the user request to one or more software components provided in the application mechanism 10, the service mechanism 20, and the like. The data management unit 23 defines how to store and where to store information with respect to various types of information items such as user information that is to be stored inside or outside the device.

The marking service 24 performs the process of extracting embedded information or the process of embedding information with respect to image data in response to a request issued from the marking filter 135.

The device mechanism 30 includes a device control mechanism separately for each device provided for the multifunctional machine 1.

The operating unit 40 is a part in which software components relating to the operation and management of the system are implemented, and is used in a shared manner by the application mechanism 10, the service mechanism 20, and the device mechanism 30. In FIG. 2, the operating unit 40 includes a plug-in management unit 41. The plug-in management unit 41 manages information about software components such as activities and filters that can be freely installed and uninstalled.

In the following, the function to extract embedded information or the function to embed information (which will hereinafter be referred to as a “marking function”) will be described with respect to the multifunctional machine 1 having the software configuration described above.

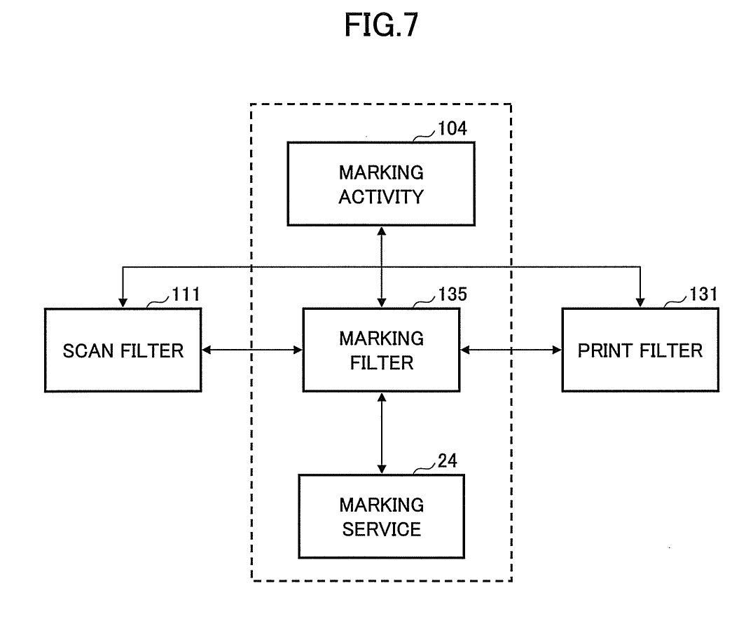

FIG. 7 is a drawing showing an example of the configuration of software components for implementing the marking function. A job for the marking function (which will hereinafter be referred to as “marking job) is controlled by the marking activity 104. In FIG. 7, the marking activity 104 performs a marking job by use of a combination of the scan filter 111, the marking filter 135, and the print filter 131. The print filter 131 may not be needed for some types of marking function.

When a print-person detection job is to be performed as a marking job, the scan filter 111 controls the imaging unit 604 to scan image data from a document sheet, and, then, the marking filter 135 extracts embedded information for the print-person detection purpose (i.e., print-person detection information) that is embedded using a background form, a barcode form, or the like in the document sheet (i.e., image data). Image processing to extract the print-person detection information is performed by the marking service 24. Thereafter, the extracted information (i.e., information indicative of a print person who has printed the document) is displayed on the operation panel 602. In the case of a print-person detection job, the document edit filter 121 and the print filter 131 may not be necessary as described above.

When a tampering detection job is to be performed as a marking job, the scan filter 111 controls the imaging unit 604 to scan image data from a document sheet, and, then, the marking filter 135 reads tampering-detection-purpose embedded information for the image data. Namely, the marking filter 135 extracts the tampering-detection-purpose embedded information (i.e., tampering detection information) that is embedded using a background form, a barcode form, or the like in the document sheet (i.e., image data). Image processing to extract the tampering detection information is performed by the marking service 24. The marking service 24 further detects the presence or absence of tampering based on the tampering detection information and identifies an altered portion when there is tampering, followed by performing image processing to attach a red circular mark to the identified portion, for example. The detection of tampering and checking of an altered portion using a background pattern are disclosed in Japanese Patent Application Publications 2005-12530 and 2005-192148.

When the marking service 24 detects tampering, the marking filter 135 outputs image data with a red circular mark attached to the altered position to the document edit filter 121. The image data is then printed by the print filter 131. In this manner, a user may learn the presence of tampering and the position of the altered portion by looking at the printed document. If the marking service 24 detects no tampering, a message indicative of the absence of tampering is displayed on the operation panel 602. With this, the tampering detection job comes to an end. In this case, the document edit filter 121 and the print filter 131 are not utilized.

The example illustrated in FIG. 7 uses the scan filter 111 as an input filter and the print filter 131 as an output filter. It should be noted, however, that the input filter and the output filter may properly be changed depending on the type of a job to be performed.

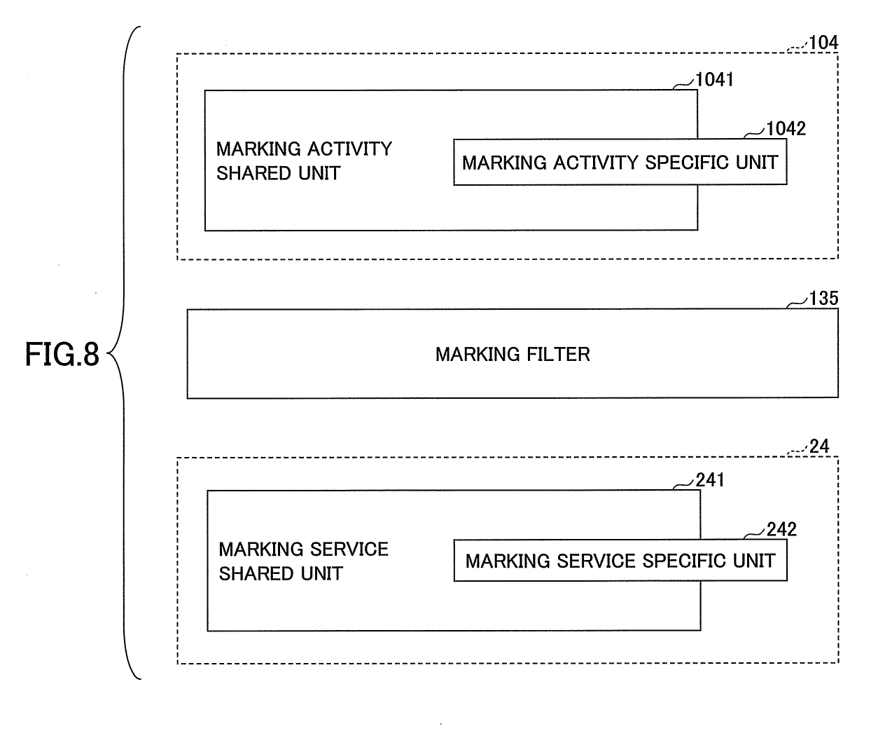

In the following, a description will be further given of the software components that may be main components to implement the marking function. These software components are illustrated as being enclosed in a dotted-line frame. FIG. 8 is a drawing showing an example of the configuration of a marking activity, a marking filter, and a marking service.

In FIG. 8, the marking activity 104 includes a marking activity shared unit 1041 and a marking activity specific unit 1042. The marking activity shared unit 1041 is a part in which processes performed in a shared manner for different types of marking jobs are implemented among the processes that are performed as the marking activity 104. The marking activity specific unit 1042 is a part that performs processes specific to the type of the marking job. The marking activity specific unit 1042 is implemented separately for each type of marking job. The marking activity specific unit 1042 is provided with an interface (i.e., function or method) defined with respect to the marking activity shared unit 1041. In other words, the marking activity specific unit 1042 is created by implementing processes specific to the type of the marking job for the relevant function or the like.

By the same token, the marking service 24 includes a marking service shared unit 241 and a marking service specific unit 242. The marking service shared unit 241 is a part in which processes performed in a shared manner for different types of marking processes are implemented among the processes that are performed as the marking service 24. The marking service specific unit 242 is a part that performs processes specific to the type of the marking process. The marking service specific unit 1042 is implemented separately for each type of marking process. The marking service specific unit 242 is provided with an interface (i.e., function or method) defined with respect to the marking service shared unit 241. In other words, the marking service specific unit 242 is created by implementing processes specific to the type of the marking process for the relevant function or the like.

The marking filter 135 is configured to be universally usable for different types of marking functions. One and the same marking filter 135 can thus be used regardless of types of marking functions. Such an arrangement is possible because the portions differing between different types of marking functions are absorbed by the marking activity specific unit 1042 and the marking service specific unit 242.

In FIG. 8, the portions common to different types of marking functions (i.e., the marking activity shared unit 1041, the marking filter 135, and the marking service shared unit 241) serve as a framework (hereinafter referred to as a “marking framework”) for implementing a marking function. Namely, when a marking function is to be implemented, it suffices to implement a portion (i.e., the marking activity specific unit 1042 and the marking service specific unit 242) other than the marking framework according to interfaces defined with respect to the marking framework.

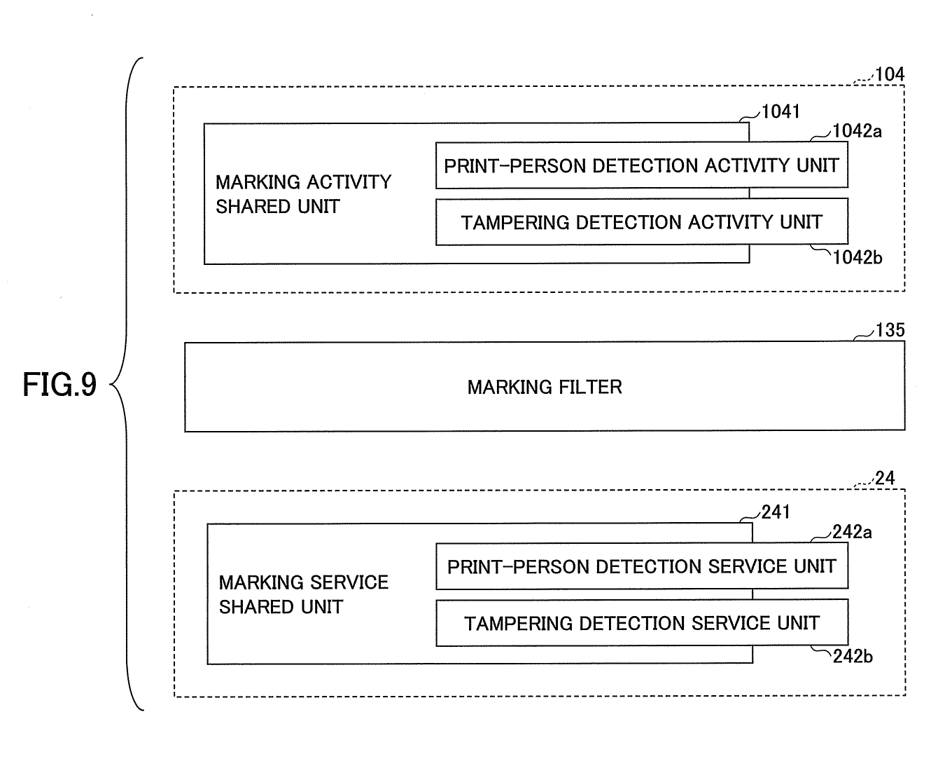

FIG. 9 is a drawing showing an example of a configuration in which the print-person detection function and the tampering detection function are implemented with respect to a marking framework.

FIG. 9 shows an example in which a print-person detection activity unit 1042a and a tampering detection activity unit 1042b are plugged-in as the marking activity specific unit 1042. FIG. 9 further shows an example in which a print-person detection service unit 242a and a tampering detection service unit 242b are plugged-in as the marking service specific unit 242. With the arrangement illustrated in FIG. 9, it is possible to perform a print-person detection job and a tampering detection job.

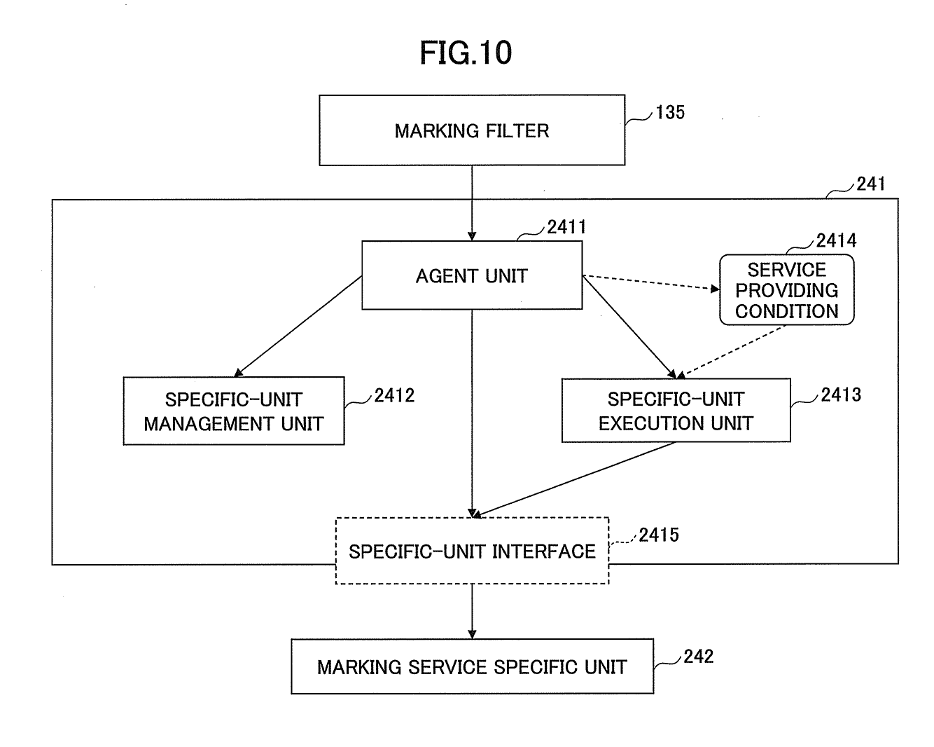

FIG. 10 is a drawing showing an example of the configuration of the marking service shared unit. In FIG. 10, the marking service shared unit 241 includes an agent unit 2411, a specific-unit management unit 2412, a specific-unit execution unit 2413, and a service providing condition 2414.

The agent unit 2411 serves as a service counter or the like for the marking service shared unit 241. The agent unit 2411 provides the marking filter 135 with a common interface (i.e., function or method) shared by different types of marking functions. The agent unit 2411 receives various types of requests from the marking filter 135 via the common interface, and passes the requests to the marking service specific unit 242. In this manner, the marking service specific unit 242 is not directly called by the marking filter 135. With this arrangement, the marking filter 135 can utilize the marking service 24 without being conscious of what kind of marking function is being performed.

The specific-unit management unit 2412 manages the marking service specific unit 242. Specifically, the specific-unit management unit 2412 manages a list of installed marking service specific units 242, and, also, loads the marking service specific units 242 (e.g., by converting an object into an instance).

The service providing condition 2414 is data (i.e., object) for storing the operating conditions of the process of the marking service 24 used at the time of job execution. Specifically, the service providing condition 2414 stores information (i.e., an instance itself or reference to an instance) for identifying an instance of the marking service specific unit 242 utilized by the job to be executed.

The specific-unit execution unit 2413 causes a marking service specific unit 242 specified by the information stored in the service providing condition 2414 to perform a specific process (responsive to the marking function) in response to a request from the agent unit 2411.

In FIG. 10, a specific-unit interface 2415 is illustrated. The specific-unit interface 2415 does not exist as a tangible object, but indicates an interface that the marking service specific unit 242 is supposed to have. As a general principle, the specific-unit interface 2415 corresponds to (i.e., paired with) the interface that is provided by the agent unit 2411 for the marking filter 135. The agent unit 2411, the specific-unit execution unit 2413, and the like pass a request from the marking filter 135 to the marking service specific unit 242 by use of the specific-unit interface 2415.

In the following, a description will be given of a procedure that is performed by the multifunctional machine 1 at the time of executing a marking function. An initialization process for a marking job will be described first. The initialization process refers to a preparation for performing a marking job. Such an initialization process is automatically performed at the time of power-on of the multifunctional machine 1, for example. It should be noted that such an initialization process may also be performed in response to a user request to perform a marking job (e.g., in response to an operation to select a button corresponding to a marking job on the operation panel 602).

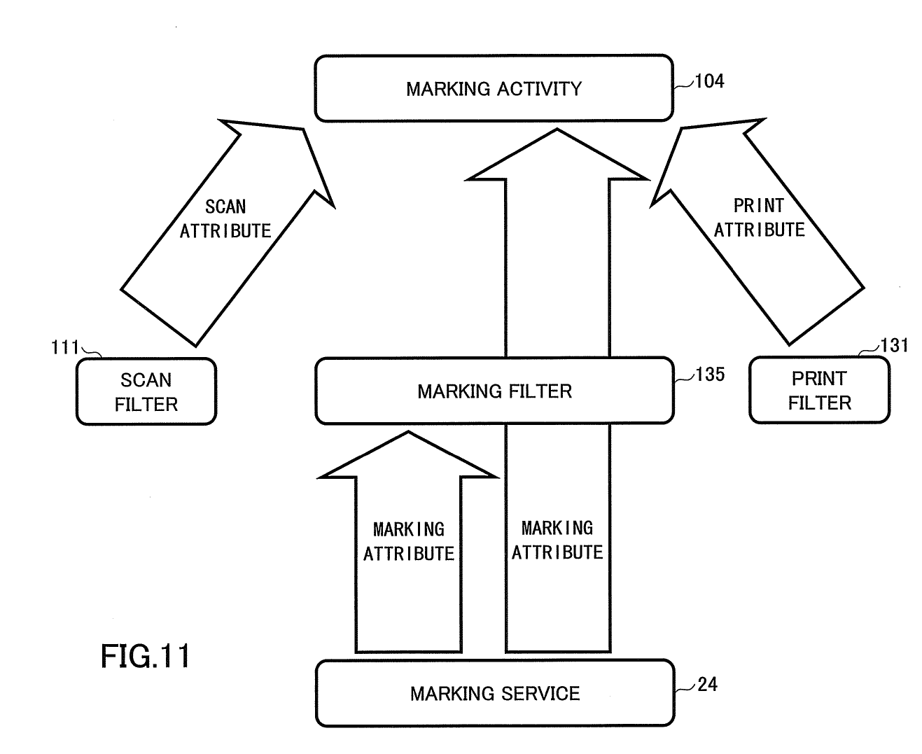

FIG. 11 is a drawing illustrating the outline of an initialization process performed for a marking job. As illustrated in FIG. 11, in the initialization process, each filter sets configuration information (i.e., an attribute name, a data type, an attribute value (initial value)) regarding parameters (attribute items (setting items)) constituting the operating conditions that need to be set for each filter (e.g., the scan filter 111, the marking filter 135, and the print filter 131) used in the marking job. The setting of the configuration information is performed with respect to the marking activity 104. The operating conditions of the scan filter 111 are referred to as scan attributes. The operating conditions of the marking filter 135 are referred to as marking attributes. The operating conditions of the print filter 131 are referred to as print attributes.

What is notable in FIG. 11 is that the setting of marking attributes to the marking activity 104 is not performed by the marking filter 135, but is delegated to the marking service 24. This is because the configuration of marking attributes differ for different marking service specific units 242 installed in the multifunctional machine 1. The delegation of the setting of marking attributes to the marking service 24 ensures the universal applicability of the marking filter 135. It should be noted that the marking attributes are also set to the marking filter 135.

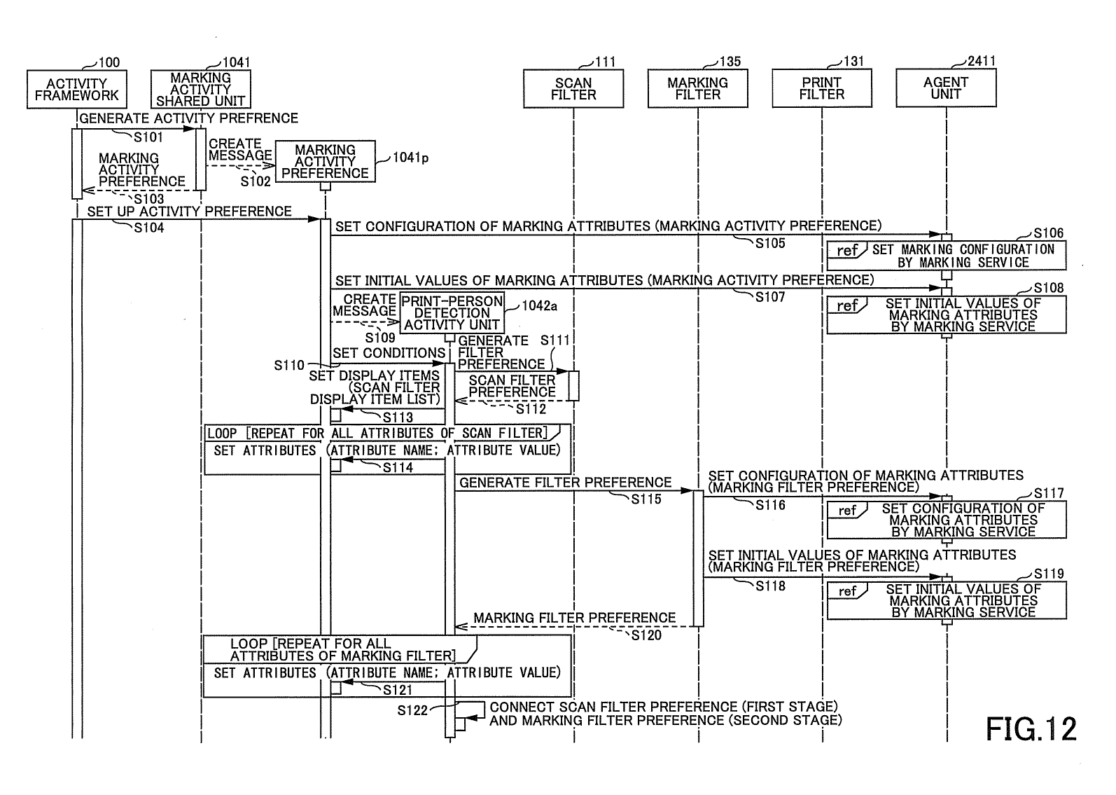

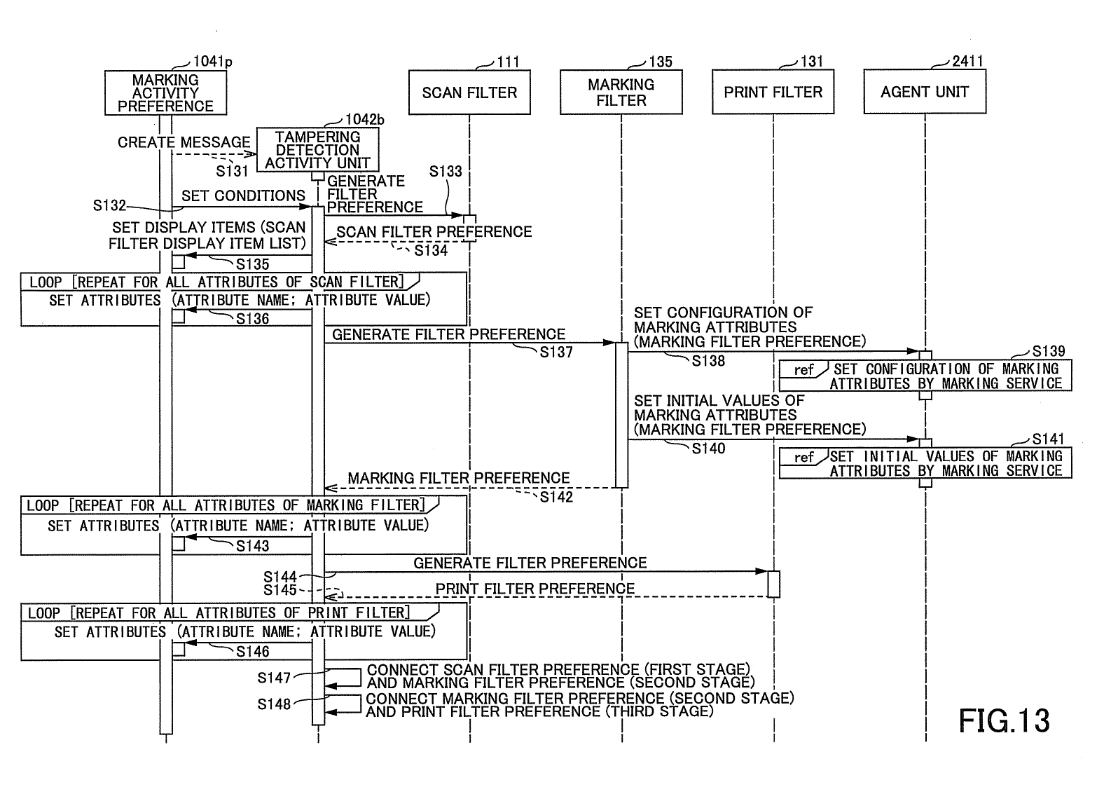

The initialization process will be further described in the following. FIGS. 12 and 13 are sequence diagrams illustrating the initialization process performed for a marking job.

In step S101, the activity framework 100 requests the marking activity shared unit 1041 to generate a preference. The term “preference” refers to an object that constitutes part of an activity logic or filter logic, and that is used to store information about attribute items constituting the operating conditions of a job or the like. Specifically, a preference stores an attribute name, a data type, an attribute value, and so on with respect to each attribute item.

The marking activity shared unit 1041 generates (i.e., converts into an instance) a marking activity preference 1041p as a preference for a marking job (S102). The marking activity shared unit 1041 then returns the generated marking activity preference 1041p to the activity framework 100 (S103). At this point in time, the contents of the marking activity preference 1041p are empty. Namely, configuration information is not yet set to the attribute items of operating conditions.

The activity framework 100 requests the marking activity preference 1041p to set up the marking activity preference 1041p (i.e., to set configuration information about the attribute items of operating conditions). In response to the request, the marking activity preference 1041p requests (S105), by using itself (i.e., marking activity preference 1041p) as an argument indicative of an instance, the agent unit 2411 of the marking service shared unit 241 to set configuration information about the marking attributes (i.e., attribute name and data type of each attribute item). In response to the request, the marking service 24 sets configuration information about the marking attributes (i.e., attribute name and data type) to the marking activity preference 1041p (S106). The details of step S106 will later be described.

After this, the marking activity preference 1041p requests the agent unit 2411 (S107) to set attribute values (i.e., initial values in this case) to the marking activity preference 1041p. In response to the request, the marking service 24 sets (S108) an initial value (i.e., default value) to each attribute item of the marking attributes for which configuration information has been set in step S106. The details of step S108 will later be described.

In step S106 and S108 as described above, the schema definition (i.e., an attribute name and data type of each attribute item) and initial values of marking attributes are defined with respect to the empty marking activity preference 1041p. The reason why such definition is dynamically made by the marking service 24 is because the configuration of marking attributes differs depending on what kind of marking service specific unit 242 is plugged in, and, thus, cannot be fixed to a predetermined configuration in advance.

The marking activity preference 1041p then causes the currently installed marking service specific units 242 to set configuration information about operating conditions needed to perform respective specific marking functions. Here, the marking service specific units 242 installed in the present embodiment are the print-person detection activity unit 1042a and the tampering detection activity unit 1042b.

Specifically, the marking activity preference 1041p converts the print-person detection activity unit 1042a into an instance (S109). The marking activity preference 1041p then requests (S110) the print-person detection activity unit 1042a to set information regarding the operating conditions of a print-person detection job (i.e., make settings to the marking activity preference 1041p). In response to the request, the print-person detection activity unit 1042a acquires a preference (i.e., filter preference) for storing information about operating conditions from each of the filters (i.e., the scan filter 111 and the marking filter 135) used in a print-person detection job.

Specifically, the print-person detection activity unit 1042a requests the scan filter 111 to generate a filter preference (S111). The scan filter 111 generates a filter preference (i.e., scan filter preference) in which an attribute name, data type, and initial value of each attribute item constituting the scan attributes are stored, followed by returning the scan filter preference to the print-person detection activity unit 1042a (S112).

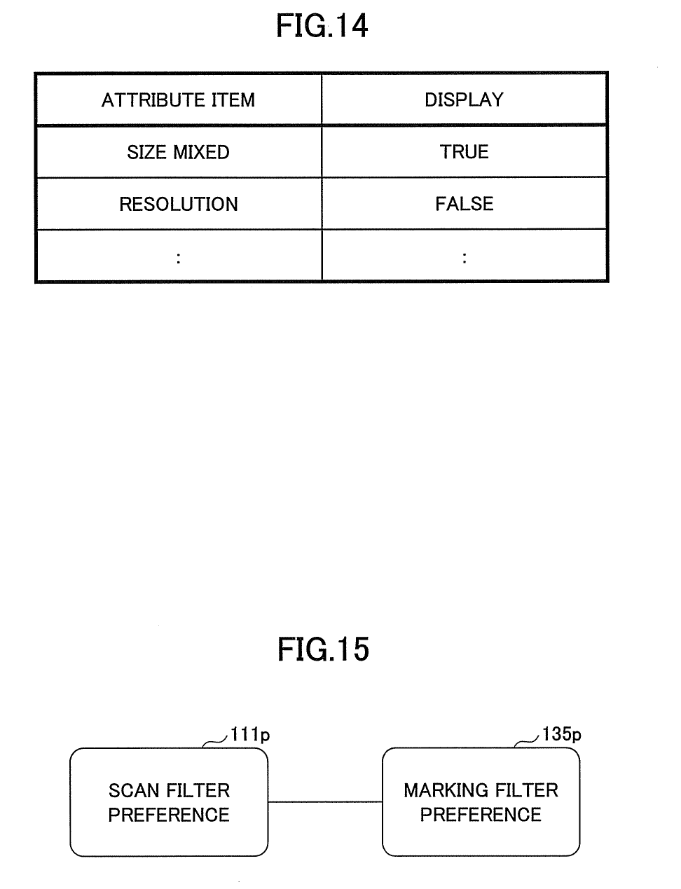

Thereafter, the print-person detection activity unit 1042a sets (S113) to the marking activity preference 1041p a list of attribute names regarding attribute items (display items) for displaying on a UI screen (i.e., setting screen) among the attribute items set in the scan filter preference. It should be noted that the scan filter 111 is configured to be universally usable by various types of activities (i.e., various types of applications). Accordingly, the attribute items of the scan filter 111 also have universal configurations. When a print-person detection job is to be performed, however, some of the attribute items (e.g., resolution) of the scan filter 111 may need to have predetermined values (i.e., fixed values). Such attribute items are not displayed on the setting screen, so that a list of display items excluding such non-display attribute items is set in the marking activity preference 1041p. A check as to which items are to be displayed may be made by use of information coded as hard logic settings, or may be made based on information (e.g., display item definition table) stored in the HDD 633 in a table format as illustrated in FIG. 14. The latter case may provide an advantage in that functional extension can be flexibly made. In an example shown in FIG. 14, the attribute items having “TRUE” in their display flag will be treated as display items.

Thereafter, the print-person detection activity unit 1042a sets (S114) to the marking activity preference 1041p an attribute name and an attribute value (i.e., initial value) for each attribute item set in the scan filter preference.

The print-person detection activity unit 1042a then repeats for the marking filter 135 processes similar to those performed for the scan filter 111. The print-person detection activity unit 1042a requests the marking filter 135 to generate a filter preference (S115). The marking filter 135 generates an empty filter preference (i.e., marking filter preference) for use with respect to the marking filter 135, followed by requesting the agent unit 2411 of the marking service shared unit 241 to set configuration information about marking attributes to the marking preference (S116). In response to the request, the marking service 24 sets configuration information about the marking attributes (i.e., attribute name and data type) to the marking filter preference (S117). The details of step S117 will later be described.

After this, the marking filter 135 requests the agent unit 2411 (S118) to set attribute values (i.e., initial attribute values in this case) to the marking filter preference. In response to the request, the marking service 24 sets (S119) an initial value (i.e., default value) to each attribute item of the marking attributes for which configuration information has been set in step S117. The details of step S119 will later be described. The marking filter 135 then returns the marking filter preference to the print-person detection activity unit 1042a (S120).

Thereafter, the print-person detection activity unit 1042a sets (S121) to the marking activity preference 1041p an attribute name and an attribute value (i.e., initial value) for each attribute item set in the marking filter preference.

After this, the print-person detection activity unit 1042a connects (S122) the respective filter preferences (i.e., scan filter preference and marking filter preference) of the scan filter 111 and the marking filter 135 used in a print-person detection job, such that these preferences are connected together in a sequence in which the filters are to operate. Namely, filter connection relationships are determined. In this case, the scan filter preference is situated in a first stage (preceding stage), and the marking filter preference is situated in a second stage (following stage). FIG. 15 is a drawing illustrating the way a scan filter preference 111p and a marking filter preference 135p are connected together.

Referring to FIG. 13 again, the marking activity preference 1041p causes the tampering detection activity unit 1042b to perform processes similar to the processes performed by the print-person detection activity unit 1042a in step S111 to step S122. Specifically, the marking activity preference 1041p converts the tampering detection activity unit 1042b into an instance (S131). The marking activity preference 1041p then requests (S132) the tampering detection activity unit 1042b to set information regarding the operating conditions of a tampering detection job (i.e., make settings to the marking activity preference 1041p). In response to the request, the tampering detection activity unit 1042b acquires a preference (i.e., filter preference) for storing information about operating conditions from each of the filters (i.e., the scan filter 111, the marking filter 135, and the print filter 131) used in a tampering detection job.

Specifically, the tampering detection activity unit 1042b requests the scan filter 111 to generate a filter preference (S133). Similarly to step S112, the scan filter 111 generates a scan filter preference, and returns the scan filter preference to the tampering detection activity unit 1042b (S134). The instance of the scan filter preference generated as described above is different from the one generated in step S112.

Thereafter, the tampering detection activity unit 1042b sets (S135) to the marking activity preference 1041p a list of attribute names regarding display items among the attribute items set in the scan filter preference. Thereafter, the tampering detection activity unit 1042b sets (S136) to the marking activity preference 1041p an attribute name and an attribute value (i.e., initial value) for each attribute item set in the scan filter preference.

Under the control of the tampering detection activity unit 1042b, then, processes similar to those performed in steps S115 to S121 are performed with respect to the marking filter 135 (S137 to S143). Consequently, the marking filter preference is generated, and an attribute name and attribute value of each attribute item set in the marking filter preference are set in the marking activity preference 1041p. The instance of the marking filter preference generated in step S137 is different from the one generated in step S116.

The tampering detection activity unit 1042b then repeats for the print filter 131 processes similar to those performed for the scan filter 111 and the like. Specifically, the tampering detection activity unit 1042b requests the print filter 131 to generate a filter preference (S144). The print filter 131 generates a filter preference (i.e., print filter preference) conforming to the operating conditions of the print filter 131 (i.e., in which an attribute name, data type, and initial value of each attribute item constituting the operating conditions of the print filter 131 are stored), followed by returning the print filter preference to the tampering detection activity unit 1042b (S145). Thereafter, the tampering detection activity unit 1042b sets (S146) to the marking activity preference 1041p an attribute name and an attribute value (i.e., initial value) for each attribute item set in the print filter preference.

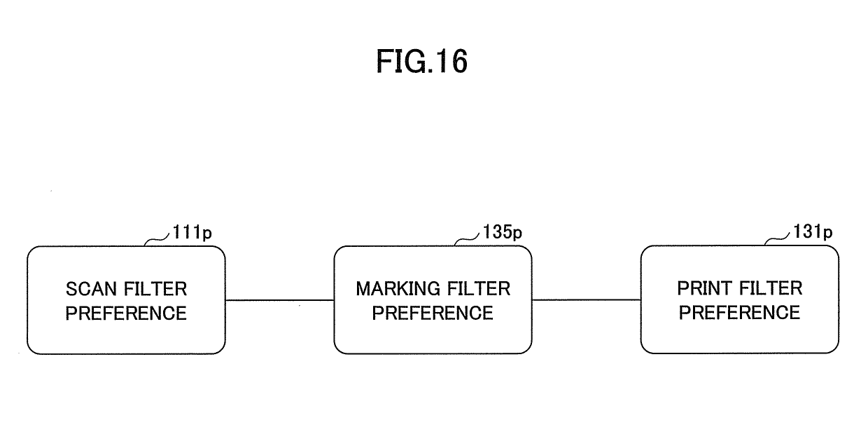

After this, the tampering detection activity unit 1042b connects (S147) the scan filter preference and the marking filter preference in a sequence in which the filters operate. Further, the tampering detection activity unit 1042b connects (S148) the marking filter preference and the print filter preference in a sequence in which the filters operate. As a result, the scan filter preference, the marking filter preference, and the print filter preference are connected in the order named. FIG. 16 is a drawing illustrating the way the scan filter preference 111p, the marking filter preference 135p, and a print filter preference 131p are connected together.

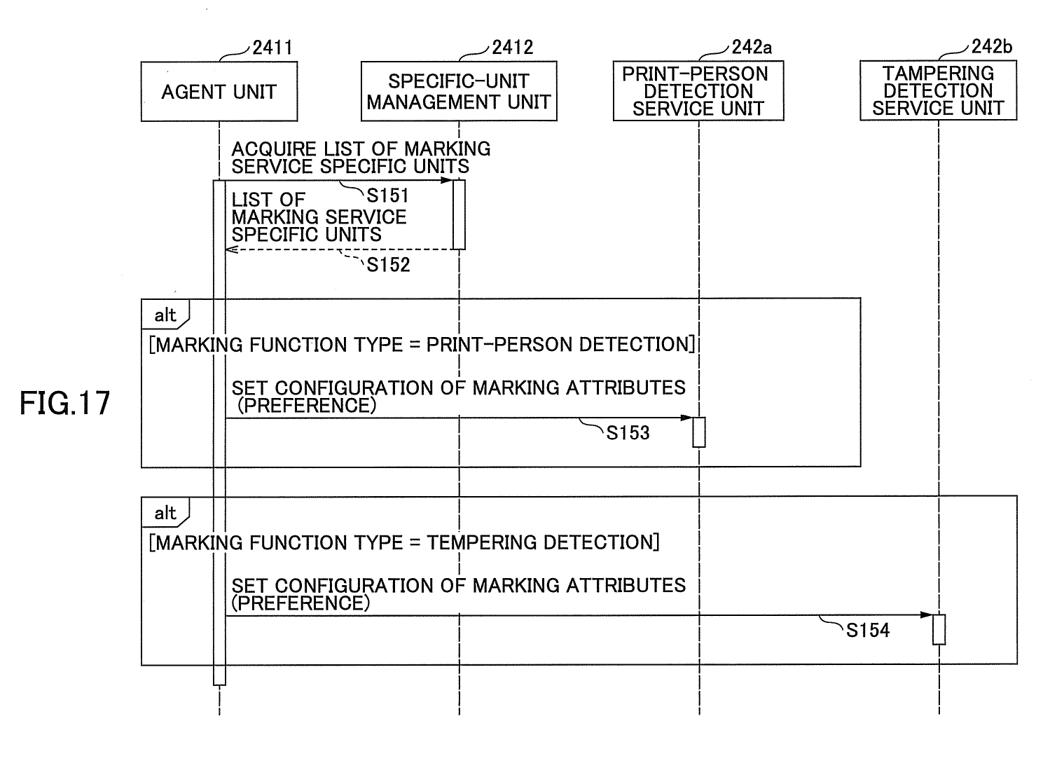

In the following, the process performed in steps S106, S117, and S139 will be described. FIG. 17 is a sequence chart illustrating the setting of configuration information about marking attributes with respect to a marking service preference.

The agent unit 2411 acquires a list of instances (objects) of the marking service specific units 242 (which will hereinafter be referred to as a “list of marking service specific units”) installed in the multifunctional machine 1 from the specific-unit management unit 2412 (S151, S152). It is assumed that the specific-unit management unit 2412 has already loaded the instances of the marking service specific units 242 to the memory for management purposes.

The following procedure proceeds through different branches depending on a marking function type. The marking function type is information indicative of the type of a marking function (i.e., either the “print-person detection function” or the “tampering detection function” in the present embodiment). In the case of step S117, such information is supplied from the print-person detection activity unit 1042a in steps S115 and S116. In the case of step S139, such information is supplied from the tampering detection activity unit 1042b in steps S137 and S138.

If the marking function type indicates the print-person detection function (i.e., in the case of step S117), the agent unit 2411 requests the print-person detection service unit 242a to set configuration information about marking attributes to the preference (S153). In response to the request, the print-person detection service unit 242a sets to the preference an attribute name and data type of each attribute item required for a print-person detection job.

If the marking function type indicates the tampering detection function (i.e., in the case of step S139), the agent unit 2411 requests the tampering detection service unit 242b to set configuration information about marking attributes to the preference (S154). In response to the request, the tampering detection service unit 242b sets to the preference an attribute name and data type of each attribute item required for a tampering detection job.

In this manner, the agent unit 2411 causes the marking service specific unit 242 to respond to the request (i.e., inquiry about configuration information about marking attributes) to set configuration information about marking attributes.

It should be noted that the preference set in the procedure illustrated in FIG. 17 is the one that is supplied as an argument in step S105, S116, or S139.

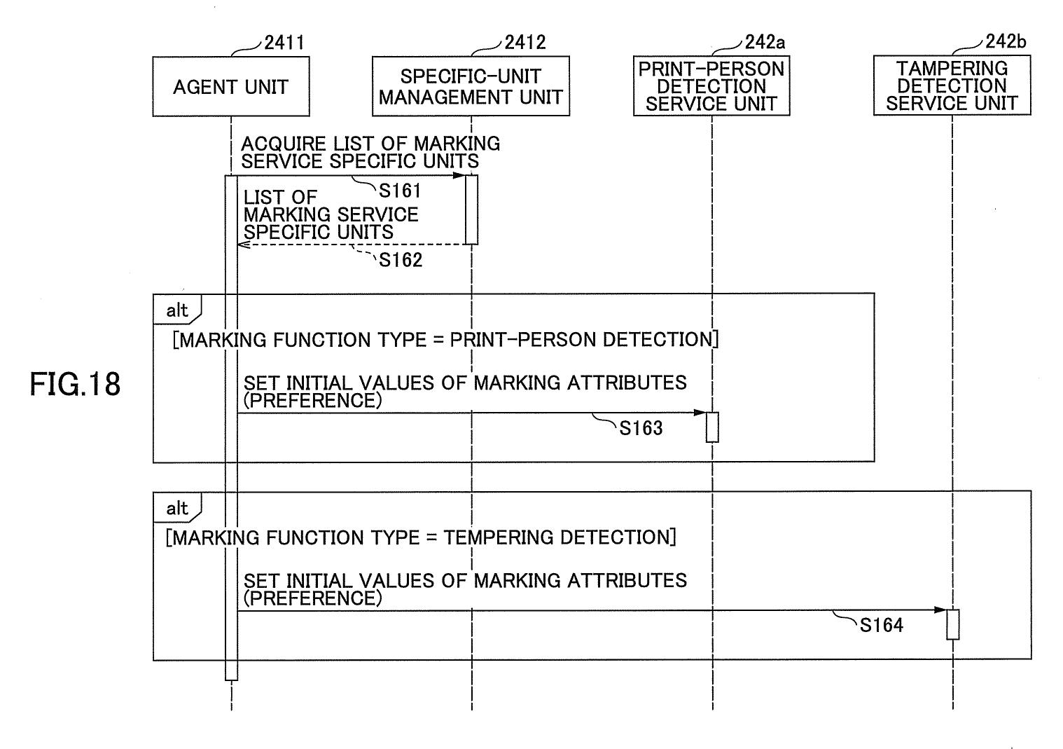

In the following, the process performed in steps S108, S119, and S141 in FIG. 12 and FIG. 13 will be described. FIG. 18 is a sequence chart illustrating the setting of initial values of marking attributes with respect to a marking service preference.

The agent unit 2411 acquires a list of marking service specific units from the specific-unit management unit 2412 (S186, S162). The following procedure proceeds through different branches depending on a marking function type.

If the marking function type indicates the print-person detection function (i.e., in the case of step S119), the agent unit 2411 requests the print-person detection service unit 242a to set the initial values of marking attributes to the preference (S163) In response to the request, the print-person detection service unit 242a sets to the preference an initial value type of each attribute item required for a print-person detection job. In this example, a value indicative of the print-person detection function is also set in the preference as the marking function type.

If the marking function type indicates the tampering detection function (i.e., in the case of step S141), the agent unit 2411 requests the tampering detection service unit 242b to set configuration information about marking attributes to the preference (S164). In response to the request, the tampering detection service unit 242b sets to the preference the initial value of each attribute item required for a tampering detection job. In this example, a value indicative of the tampering detection function is also set in the preference as the marking function type.

In this manner, the agent unit 2411 causes the marking service specific unit 242 to respond to the request (i.e., inquiry about the initial values of marking attributes) to set the initial values of marking attributes.

It should be noted that the preference set in the procedure illustrated in FIG. 18 is the one that is supplied as an argument in step S107, S118, or S140.

With this, the initialization procedure comes to an end. Among all the processes performed in the initialization procedure, only the processes relating to the print-person detection activity unit 1042a and the tampering detection activity unit 1042b in FIG. 12 and FIG. 13 may need to be implemented as a portion specific to each marking function. Further, only the processes relating to the print-person detection service unit 242a and the tampering detection service unit 242b in FIG. 17 and FIG. 18 may need to be implemented as a portion specific to each marking function.

If the multifunctional machine 1 is not provided with the marking framework, the processes relating to the marking activity shared unit 1041, the marking activity preference 1041p, the marking filter 135, and the agent unit 2411 in FIG. 12 and FIG. 13 may also need to be implemented as a portion specific to each marking function. In FIG. 17 and FIG. 18, the processes relating to the agent unit 2411 and the specific-unit management unit 2412 may also need to be implemented as a portion specific to each marking function.

In this manner, the provision of the marking framework significantly reduces the portions that need to be implemented specifically for each marking function in the implementation of an initialization procedure.

After the initialization procedure as illustrated in FIG. 12 and FIG. 13, a predetermined hard-key (i.e., button) on the operation panel 602 may be pressed by a user. In response, the multifunctional machine 1 causes a login screen to be displayed on the operation panel 602.

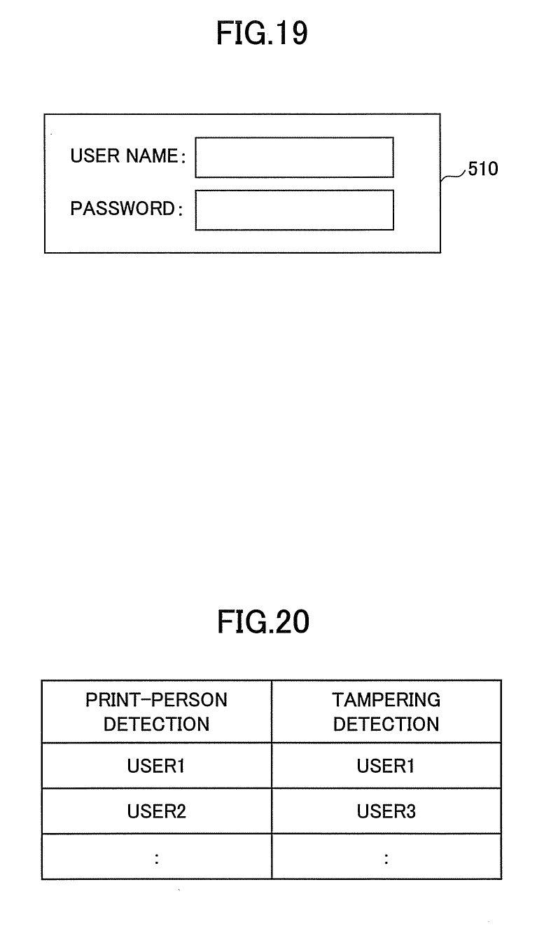

FIG. 19 is a drawing showing an example of the login screen. A user name and password are entered on a login screen 510 as illustrated in FIG. 19. In response, an authentication unit (not shown) of the multifunctional machine 1 performs user authentication. Upon successful authentication, the multifunctional machine 1 identifies marking functions available to the user according to a use authority table.

FIG. 20 is a drawing illustrating an example of a use authority table. The use authority table illustrated in FIG. 20 includes a list of user names having the authority to use each specified marking function. For the print-person detection function, for example, USER1 and USER2 have the authority to use the function. For the tampering detection function, USER1 and USER3 have the authority to use the function.

The multifunctional machine 1 then displays an application selection screen on the operation panel 602, such that only the functions identified as being available according to the use authority table are selectable.

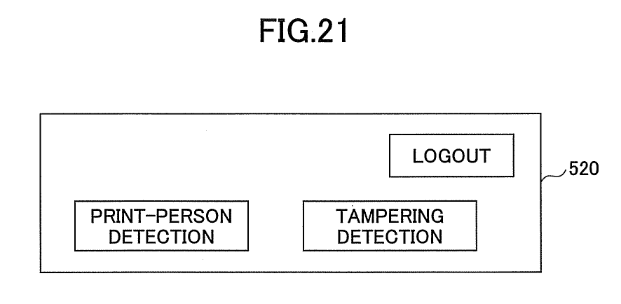

FIG. 21 is a drawing showing an example of the application selection screen. An application selection screen 520 illustrated in FIG. 21 includes a print-person detection button and a tampering detection button According to the use authority table illustrated in FIG. 20, for example, the application selection screen as illustrated in FIG. 21 would be displayed upon detecting the login of USER1.

On the application selection screen 520, a button corresponding to one of the applications (i.e., marking functions) may be selected. In response, the activity UI (see FIG. 6) of the marking activity 104 (which will hereinafter be referred to as a “marking activity UI”) causes a setting screen corresponding to the selected application (e.g., print-person detection function or tampering detection function) to be displayed on the operation panel 602. In response to the selection of the application, also, a marking function type corresponding to the selected application is recorded (i.e., stored) in the MEM-P 631.

When the print-person detection function is selected, the marking activity UI uses the print-person detection activity unit 1042a to cause a setting screen (i.e., print-person detection setting screen) to be displayed. This setting screen is used to set attribute values (i.e., operating conditions of the print-person detection job) to the attribute items provided in the marking activity preference 1041p (i.e., attribute items needed for the print-person detection job).

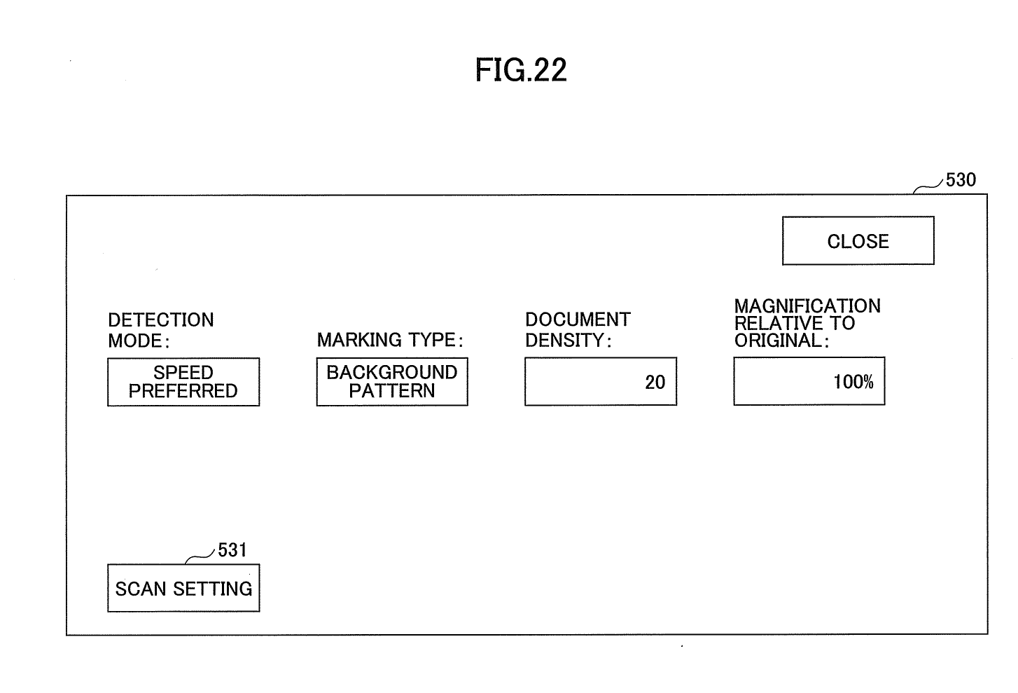

FIG. 22 is a drawing showing an example of the print-person detection setting screen. In FIG. 22, a print-person detection setting screen 530 displays display items for allowing the values of marking attribute items (i.e., attribute values) to be set with respect to a detection mode, a marking type, a document density, a magnification factor relative to the original, and so on. The print-person detection setting screen 530 in its initial state displays the initial values of attribute items set in the marking activity preference 1041p.

The print-person detection setting screen 530 also displays a scan setting button 531. Upon detecting the pressing of the scan setting button 531, the marking activity UI causes such a screen to be displayed that the scan attributes set in the marking activity preference 1041p can be set.

When the tampering detection function is selected, the marking activity UI uses the tampering detection activity unit 1042b to cause a setting screen (i.e., tampering detection setting screen) to be displayed. This setting screen is used to set attribute values (i.e., operating conditions of the tampering detection job) to the attribute items provided in the marking activity preference 1041p (i.e., attribute items needed for the tampering detection job).

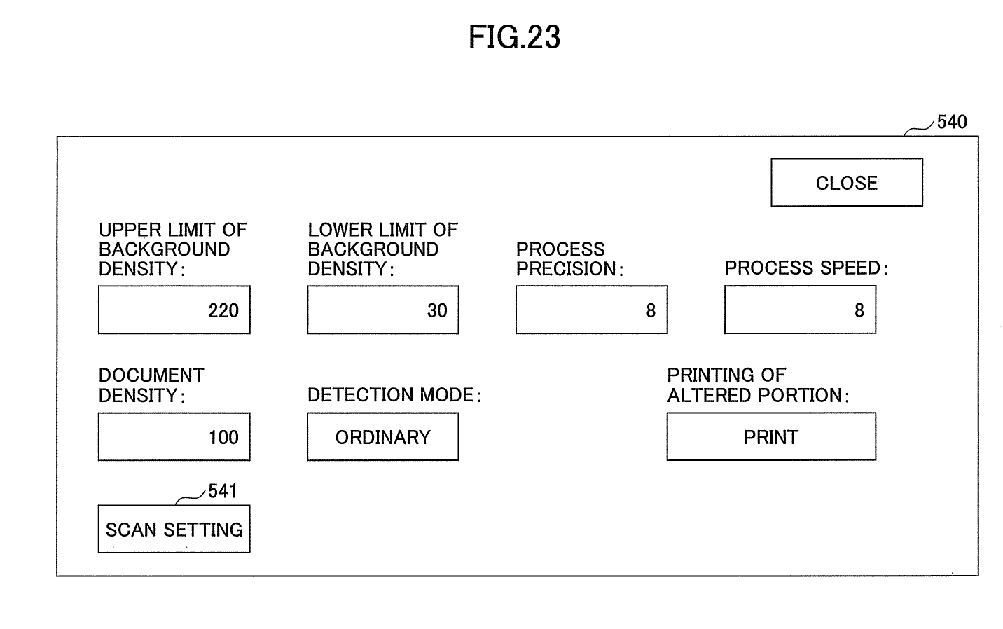

FIG. 23 is a drawing showing an example of the tampering detection setting screen. In FIG. 23, a tampering detection setting screen 540 displays display items for allowing the values of marking attribute items (i.e., attribute values) to be set with respect to the upper limit of a background pattern density, the lower limit of a background pattern density, processing precision, processing speed, document density, a detection mode, an indication of whether to print an altered portion, and so on.

The tampering detection setting screen 540 also displays a scan setting button 541. Upon detecting the pressing of the scan setting button 541, the marking activity UI causes such a screen to be displayed that attribute values can be set to the scan attributes set in the marking activity preference 1041p.

In the following, a description will be given of the procedure performed by the multifunctional machine 1 when a user makes settings to operating conditions (attribute values) for a marking job by use of a setting screen such as the print-person detection setting screen 530 or tampering detection setting screen 540.

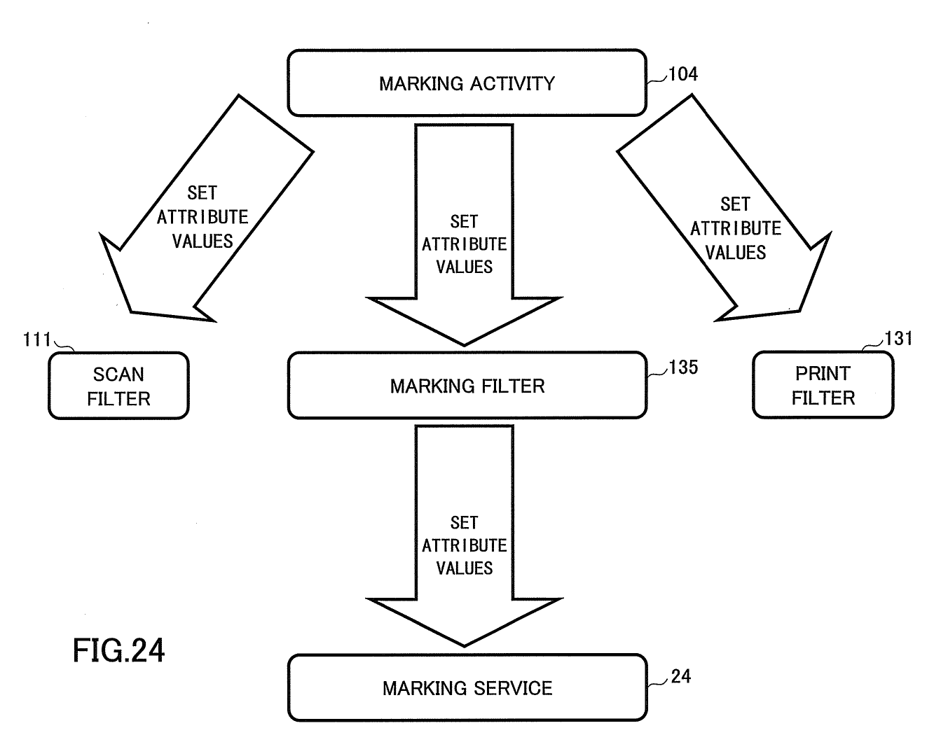

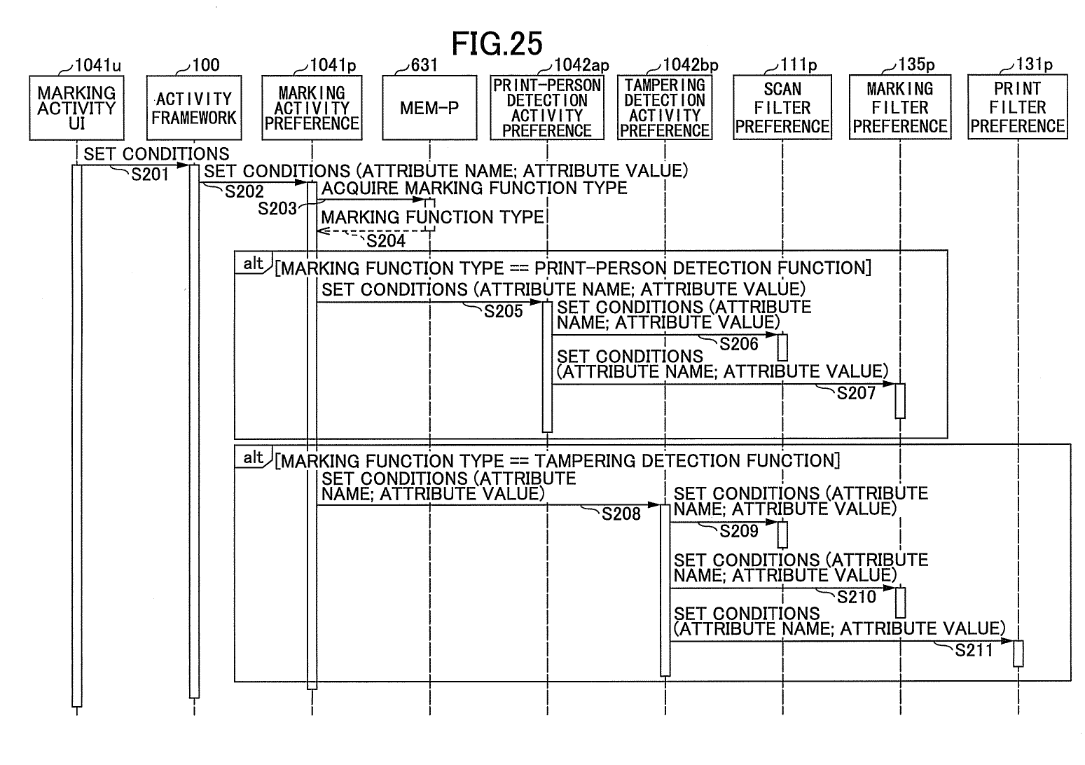

FIG. 24 is a drawing illustrating an outline of the process of setting attribute values with respect to a marking job. In the process of setting attribute values as illustrated in FIG. 24, attribute values set by a user are set to each filter through the marking activity 104. With respect to the scan filter 111, for example, the attribute values of scan attribute items are set. With respect to the marking filter 135, the attribute values of marking attribute items are set. With respect to the print filter 131, the attribute values of print attribute items are set. The attribute values set for a given filter are used by the filter when the filter performs its operation. The attribute values set for the marking filter 135, however, are used by the marking service 24. Namely, the marking filter 135 sets the attribute values to the marking service 24, and stays away from the processes (i.e., logic) that are performed based on these attribute values. With such an arrangement, the universal applicability of the marking filter 135 is ensured.

The process of setting attribute values will be further described in the following. FIG. 25 is a sequence chart illustrating the process of setting attribute values with respect to a marking job.

A user sets attribute values (i.e., the operating conditions of a print-person detection job or a tampering detection job) to attribute items on a setting screen such as the print-person detection setting screen 530 or the tampering detection setting screen 540 (S201). In response, the marking activity UI 1041u notifies the marking activity preference 1041p of the attribute items to be set and their attribute values through the activity framework 100 (S202). The marking activity preference 1041p acquires a marking function type stored in the MEM-P 631 in response to the selection of an application on the application selection screen 520 (S203), and retains the acquired marking function type (S204).

If the acquired marking function type indicates the print-person detection function, the marking activity preference 1041p notifies a print-person detection marking activity preference 1042ap of the attribute names to be set and the attribute values (S205). The print-person detection marking activity preference 1042ap is a preference for the print-person detection activity unit 1042a. The print-person detection marking activity preference 1042ap then sets the attribute values corresponding to the attribute names to the corresponding filter preference. If the attribute names are those of attribute items of scan attributes, for example, the print-person detection marking activity preference 1042ap sets the attribute values corresponding to the attribute names to the scan filter preference 111p (S206). If the attribute names are those of attribute items of marking attributes, on the other hand, the print-person detection marking activity preference 1042ap sets the attribute values to the marking filter preference 135p (S207).

If the acquired marking function type indicates the tampering detection function, the marking activity preference 1041p notifies a tampering detection marking activity preference 1042bp of the attribute names to be set and the attribute values (S208). The tampering detection marking activity preference 1042bp is a preference for the tampering detection activity unit 1042b. The tampering detection marking activity preference 1042bp then sets the attribute values corresponding to the attribute names to the corresponding filter preference. If the attribute names are those of attribute items of scan attributes, for example, the tampering detection marking activity preference 1042bp sets the attribute values corresponding to the attribute names to the scan filter preference 111p (S209). If the attribute names are those of attribute items of marking attributes, on the other hand, the tampering detection marking activity preference 1042bp sets the attribute values to the marking filter preference 135p (S207). Further, the tampering detection marking activity preference 1042bp sets the attribute names and attribute values of print attributes to the print filter preference 131p (S211) In the tampering detection setting screen 540 illustrated in FIG. 23, there is no field for setting print attributes. This is because the present embodiment is directed to an example in which the attribute values of print attributes are set to the print filter preference 131p in a fixed manner by the tampering detection marking activity preference 1042ap.

Through the processes illustrated in FIG. 25, the attribute values set by use of the print-person detection setting screen 530 or the tampering detection setting screen 540 are set to each filter preference (see FIG. 15 and FIG. 16). At this point in time, thus, the operating conditions of the print-person detection job or tampering detection job are already stored in each filter preference.

Among the processes performed in the setting of attribute values (FIG. 25), only the processes relating to the print-person detection marking activity preference 1042ap and the tampering detection marking activity preference 1042bp may need to be implemented as a portion specific to each marking function. If the multifunctional machine 1 is not provided with the marking framework, the processes relating to the marking activity preference 1041p and the marking filter preference 135p may also need to be implemented as a portion specific to each marking function. In this manner, the provision of the marking framework significantly reduces the portions that need to be implemented specifically for each marking function in the implementation of an attribute-value setting procedure.

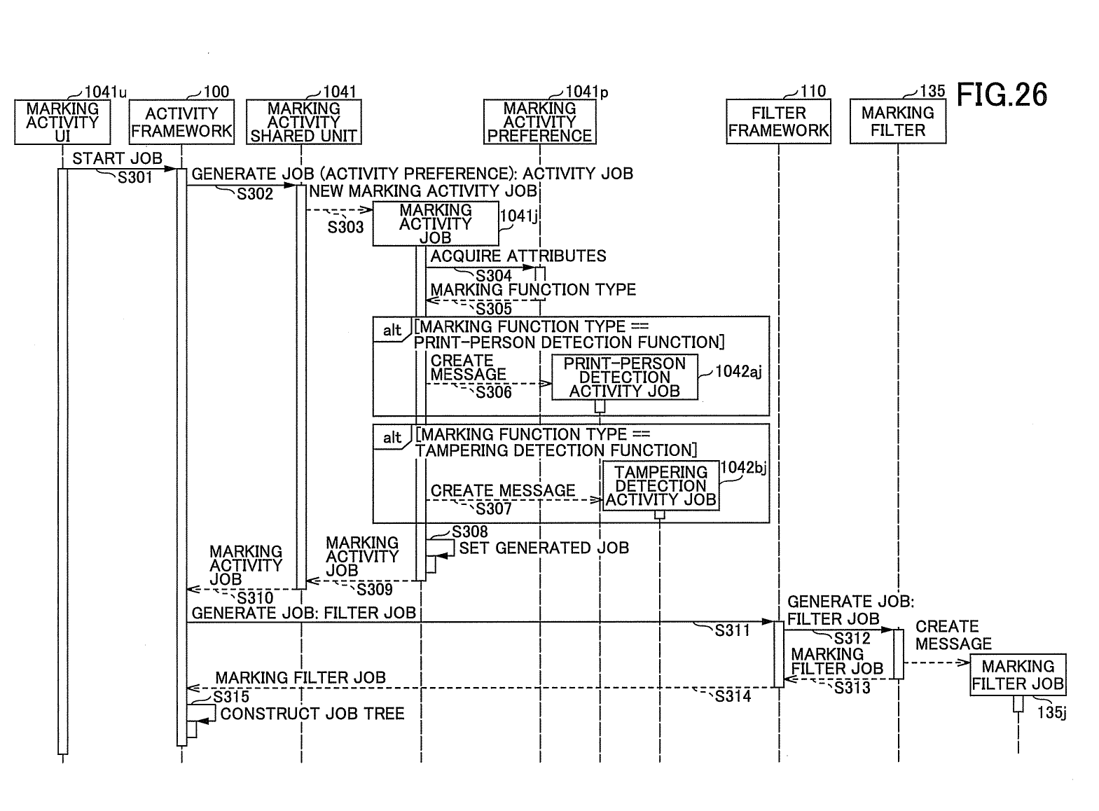

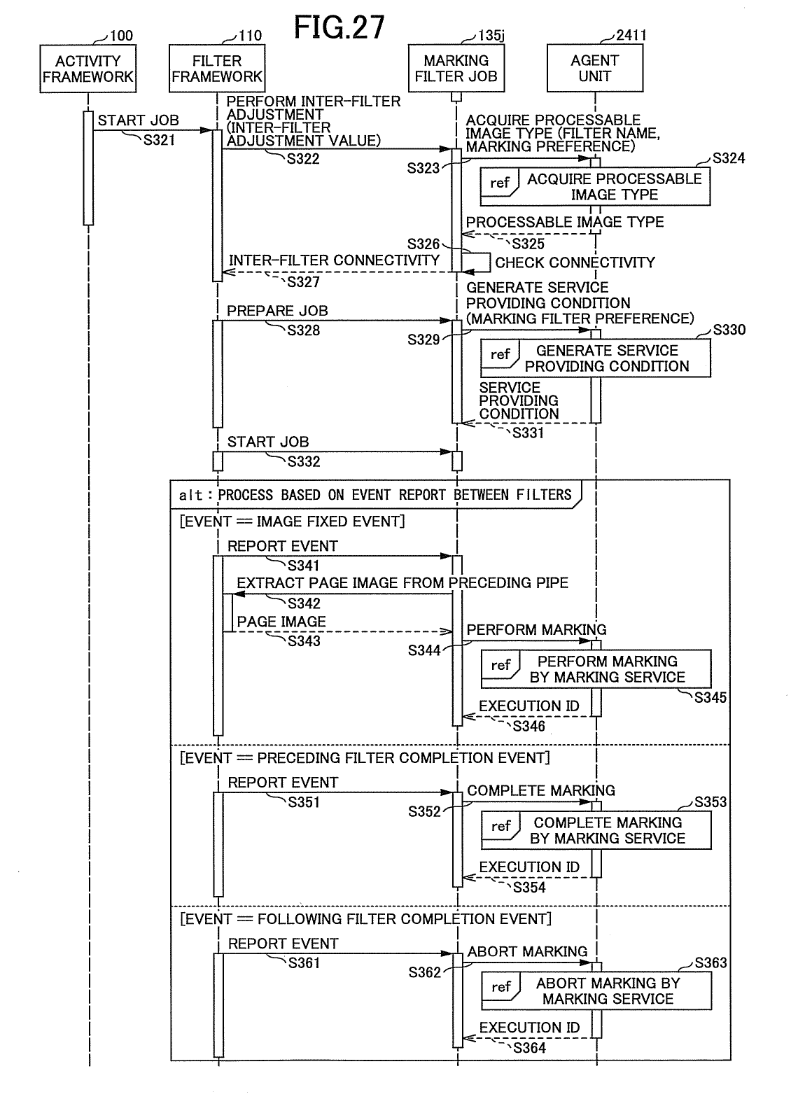

FIGS. 26 and 27 are sequence diagrams illustrating the process of performing a marking job.

After the attribute values (i.e., job operating conditions) are set on the print-person detection setting screen 530 or the tampering detection setting screen 540, a user presses a start button on the operation panel 602. In response, the marking activity UI 1041u requests the activity framework 100 to start the job (S301). The activity framework 100 then requests the marking activity shared unit 1041, by indicating the marking activity preference 1041p in an argument, to generate a job object (S302). Here, the job object is an object that constitutes an activity logic or filter logic. The job object is generated separately for each activity or filter used in a job each time the job is started, thereby controlling the operation of the job. Connection relationships between job objects represent a sequence in which filters operate and so on.

The marking activity shared unit 1041 generates (S303) a job object (i.e., marking activity job 1041j) corresponding to the marking activity 104 (i.e., marking activity shared unit 1041). In so doing, the marking activity shared unit 1041 passes an argument indicative of the marking activity preference 1041p to the marking activity job 1041j. The marking activity job 1041j then acquires a marking function type from the marking activity preference 1041p (S304, S305).

Thereafter, the marking activity job 1041j generates a job object corresponding to the marking activity specific unit 1042. Specifically, if the acquired marking function type indicates the print-person detection function, the marking activity job 1041j generates a print-person detection activity job 1042aj that is a job object corresponding to the print-person detection activity unit 1042a (S306). If the acquired marking function type indicates the tampering detection function, the marking activity job 1041j generates a tampering detection activity job 1042bj that is a job object corresponding to the tampering detection activity unit 1042b (S307). Following step S306 or S307, the marking activity job 1041j sets (i.e., stores) the generated print-person detection activity job 1042aj or tampering detection activity job 1042bj to itself (i.e., marking activity job 1041j) (S308). The marking activity job 1041j then returns its own instance to the marking activity shared unit 1041 (S309). The marking activity shared unit 1041 returns the marking activity job 1041j to the activity framework 100 (S310).

After the above-noted processes, the activity framework 100 requests the filter framework 110 to generate a job object for each filter (S311). The filter framework 110 generates a job object for each filter based on the filter preference corresponding to the marking job to be performed. For example, the filter framework 110 requests the marking filter 135 to generate a job object (S312). The marking filter 135 generates a marking filter job 135j, and returns it to the filter framework 110 (S313). The filter framework 110 returns the marking filter job to the activity framework 100 (S314).

FIG. 26 illustrates only the processes relating to the generation of the marking filter job 135j for the sake of convenience of explanation. Job objects for other filter jobs are also created by the respective filters, and are returned to the activity framework 100 via the filter framework 110.

If the marking job to be performed is a print-person detection job, for example, a job object of the scan filter 111 (i.e., scan filter job 111j) and a job object of the marking filter 135 (i.e., marking filter job 135j) are generated based on the scan filter preference 111p and the marking filter preference 135p, respectively, which are illustrated in FIG. 15.

If the marking job to be performed is a tampering detection job, a job object of the scan filter 111 (i.e., scan filter job 111j), a job object of the marking filter 135 (i.e., marking filter job 135j), and a job object of the print filter 131 (i.e., print filter job 131j) are generated based on the scan filter preference 111p, the marking filter preference 135p, and the print filter preference 131p, respectively, which are illustrated in FIG. 16.

Through the procedure described above, the activity framework 100 collects job objects corresponding to the filters used in a marking job to be performed as well as a job object corresponding to the marking activity. The activity framework 100 connects the collected job objects to implement connect relationships corresponding to the connect relationships of the preferences (see FIG. 15 and FIG. 16), thereby configuring (i.e., generating) a job tree in the MEM-P 631 (S315). The generated job tree will be configured as follows in accordance with a marking job to be performed.

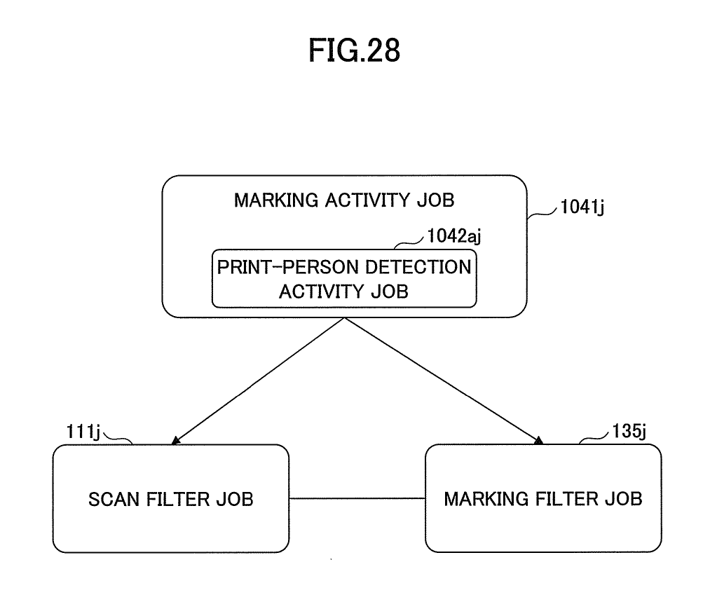

FIG. 28 is a drawing illustrating an example of a job tree obtained in the case of a print-person detection job. In the job tree illustrated in FIG. 28, the scan filter job 111j and the marking filter job 135j are connected in a sequence corresponding to the connection relationships of the preferences illustrated in FIG. 15. Further, a link indicative of the use relationships between jobs is generated for each filter job by the marking activity job 1041j to which the print-person detection activity job 1042aj is set in step S308. The job tree indicates that the print-person detection job requires filters to be performed in the following sequence: the scan filter 111->the marking filter 135.

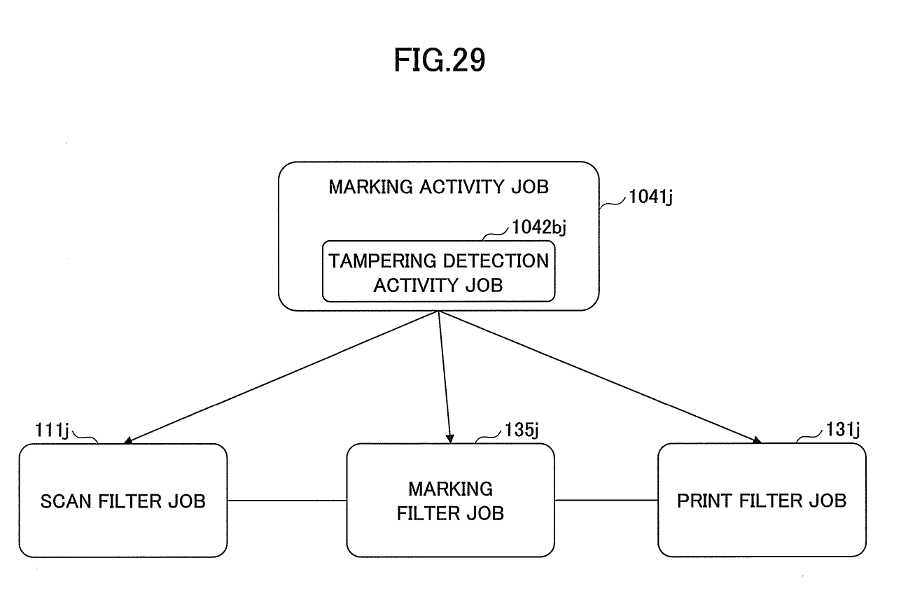

FIG. 29 is a drawing illustrating an example of a job tree obtained in the case of a tampering detection job. In the job tree illustrated in FIG. 29, the scan filter job 111j, the marking filter job 135j, and the print filter job 131j are connected in a sequence corresponding to the connection relationships of the preferences illustrated in FIG. 16. Further, a link indicative of the use relationships between jobs is generated for each filter job by the marking activity job 1041j to which the tampering detection activity job 1042bj is set in step S308. The job tree indicates that the tampering detection job requires filters to be performed in the following sequence: the scan filter 111->the marking filter 135->the print filter 131.

After the generation of a job tree, the activity framework 100 requests the filter framework 110 to start a job (S321 in FIG. 27). In response to the job start request, the filter framework 110 controls the execution of the job based on the job tree stored in the MEM-P 631. To this end, the filter framework 110 first causes each filter used in the job to attend to inter-filter adjustment.

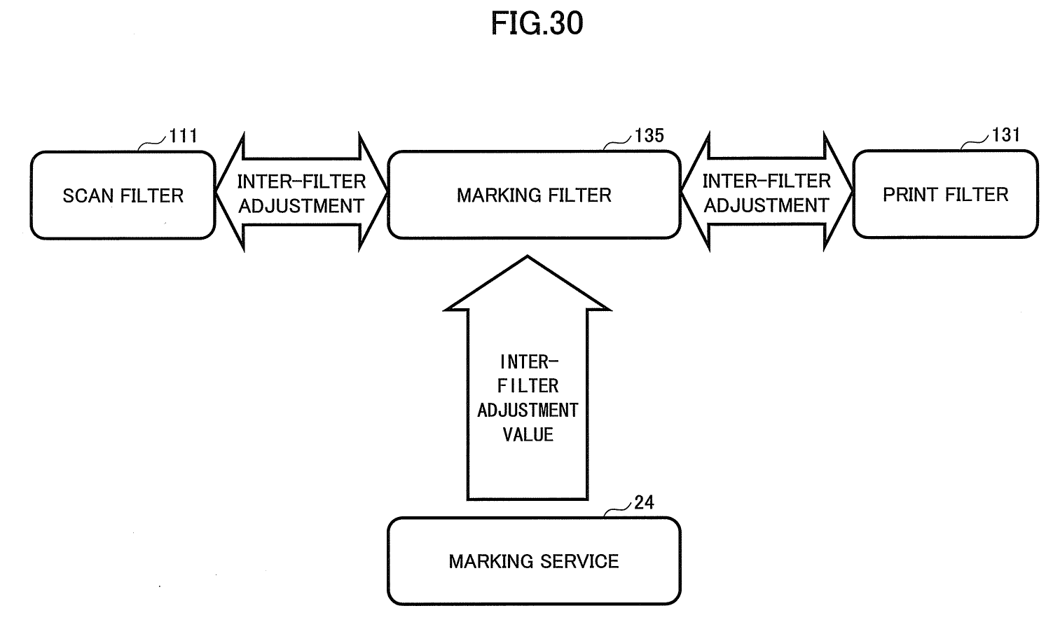

FIG. 30 is a drawing illustrating inter-filter adjustment. Inter-filter adjustment refers to a process in which the data formats (e.g., image formats) and the like of image data transmitted through a pipe are reconciled between the connected filters. For example, the scan filter 111 may output image data either in the TIFF format or in the JPEG format. The marking filter 135 may process image data provided either in the JPEG format or the BMP format (i.e., may receive the image data as proper input data). In such a case, the JPEG format is adopted as the format of the image data transmitted between these filters. Basically, each filter knows what image data it can process. The marking filter 135, however, is configured to be universally applicable. In the case of the marking filter 135, thus, information (i.e., inter-filter adjustment data) indicative of what image format can be processed is checked by making an inquiry to the marking service 24.

When an inter-filter adjustment is to be performed, the filter framework 110 instructs a filter (hereinafter referred to as a “filter C”) situated at the tail end of a filter chain connected as indicated by the job tree to perform an inter-filter adjustment. The filter C returns its inter-filter adjustment data to the filter framework 110. The filter framework 110 sends the returned inter-filter adjustment data to the filter (hereinafter referred to as a “filter B”) preceding the filter C, and requests the filter B to perform an inter-filter adjustment. The filter B checks whether it can output data in an image format indicated by the received inter-filter adjustment data. If affirmative, the filter B returns its own inter-filter adjustment data to the filter framework 110. If there is another preceding filter (hereinafter referred to as a “filter A”), the filter A will be informed of the filter B's inter-filter adjustment data, and will be requested to perform an inter-filter adjustment. In this manner, adjustments in the inter-filter adjustment are successively performed from latter-stage filters to earlier-stage filters.

Alternatively, inter-filter adjustments may be performed from the earlier-stage filters to the latter-stage filters, In such a case, the filter framework 110 instructs a filter (hereinafter referred to as a “filter A”) situated at the top end of a filter chain connected as indicated by the job tree to perform an inter-filter adjustment. The filter A returns its inter-filter adjustment data to the filter framework 110. The filter framework 110 sends the returned inter-filter adjustment data to the filter (hereinafter referred to as a “filter B”) next following the filter C, and requests the filter B to perform an inter-filter adjustment. The filter B checks whether it can output data in an image format indicated by the received inter-filter adjustment data. If affirmative, the filter B returns its own inter-filter adjustment data to the filter framework 110. If there is another next following filter (hereinafter referred to as a “filter C”), the filter C will be informed of the filter B's inter-filter adjustment data, and will be requested to perform an inter-filter adjustment.

With respect to the present embodiment, the latter case in which adjustments are successively performed from the earlier-stage filters to the latter-stage filters will be described as an example.

In FIG. 27, for the sake of convenience of explanation, only the inter-filter adjustment by the marking filter 135 is illustrated. In step S322, the filter framework 110 requests the marking filter job 135j by using an argument indicative of inter-filter adjustment data to perform an inter-filter adjustment. The above-noted inter-filter adjustment data indicated in the argument is one that is acquired from the job object (i.e., the scan filter job 111j) preceding the marking filter 135. The inter-filter adjustment data may include a list of plural image formats.

After this, the marking filter job 135j inquires of the agent unit 2411 of the marking service shared unit 241 about processable image formats as described in connection with FIG. 30 (S323). In so doing, the marking filter job 135j passes the filter name (i.e., “marking filter”) and the marking filter preference 135p as arguments to the agent unit 2411. This is because there is a possibility that processable image formats change depending on the filter used by the marking service 24 (marking service specific unit 242 to be exact) and the values of the marking filter preference 135p (i.e., marking attributes).

In response to the inquiry, the agent unit 2411 acquires image formats processable by the marking service specific unit 242 that is to be utilized (i.e., corresponding to a marking job to be performed) (S324), and returns the image formats to the marking filter job 135j (S325). Plural types of image formats may be returned. The details of step S325 will later be described.

The marking filter job 135j then compares the inter-filter adjustment data (i.e., image formats that the scan filter 111 can output) received in step S322 with the image formats returned from the agent unit 2411 to check whether the filters can be connected to each other (S326). Namely, the filters are determined to be connectable if there is a matching image format between the inter-filter adjustment data and the image formats. If no matching image format is found, on the other hand, it is determined that reconciliation between the filters is not possible. After the above-noted processes, the marking filter job 135j returns the check result (i.e., an indication of whether the filters are connectable) to the filter framework 110 (S327).

The filter framework 110 instructs all the other utilized filters (i.e., the scan filter 111 and the print filter 131) to prepare for the job if these filters are connectable to an adjacent filter. In FIG. 27, for the sake of convenience of explanation, illustration is given with respect to only the marking filter 135. In step S328, the filter framework 110 requests the marking filter job 135j to prepare to execute a job. The marking filter job 135j requests the agent unit 2411 by using an argument indicative of the marking filter preference 135p to generate the service providing condition 2414 (see FIG. 10) (S329). The agent unit 2411 generates the service providing condition 2414 (S330), and returns the service providing condition 2414 to the marking filter job 135j (S331).

When job preparation is completed with respect to all the other utilized filters, the filter framework 110 controls the execution of a marking job by utilizing each filter job object.

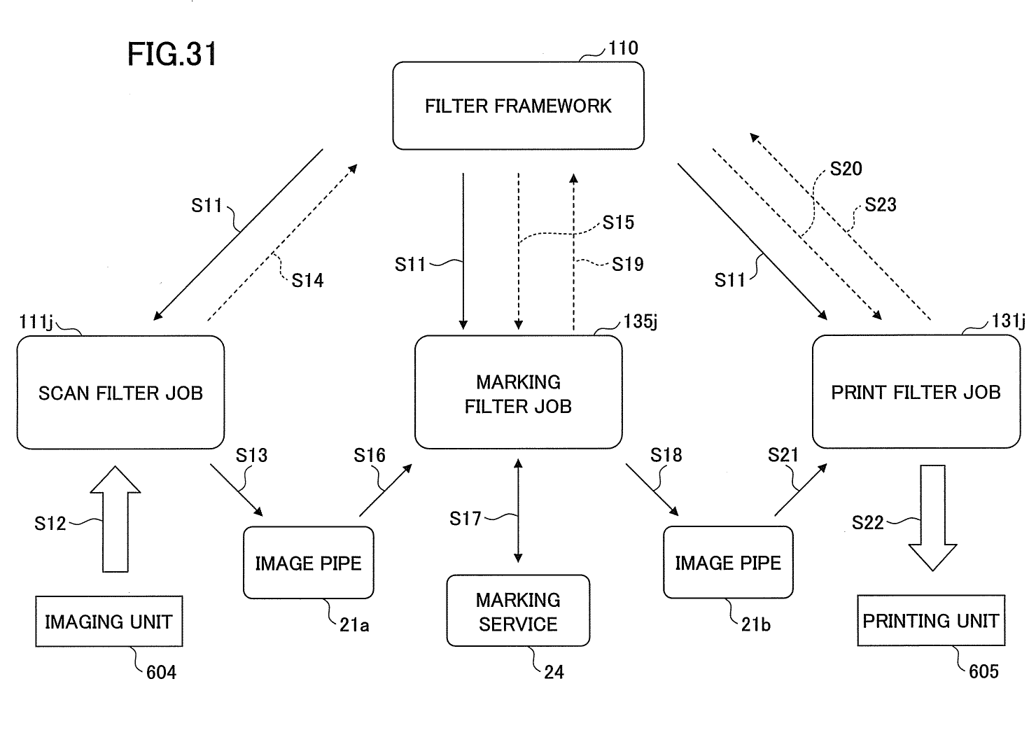

FIG. 31 is a drawing illustrating an outline of the procedure of a marking job. In FIG. 31, an image pipe 21a connects between the scan filter 111 and the marking filter 135. An image pipe 21b connects between the marking filter 135 and the print filter 131. If the job to be performed is a print-person detection job, the processes relating to the print filter job 131j are not performed.

The filter framework 110 simultaneously instructs the job objects (i.e., the scan filter job 111j, the marking filter job 135j, and the print filter job 131j) of all the filters utilized in the job to start a job (S11.) A job object of a filter that has received the job start instruction waits until an immediately preceding filter (i.e., the filter situated on the image data input side) completes its process, i.e., waits until image data is input into the image pipe 21 connected on the input side. As an exception, however, the filter situated at the top end of the job tree (i.e., the scan filter 111 in the present embodiment) starts processing without waiting.

Namely, the scan filter job 111j causes the imaging unit 604 to scan image data from a document paper sheet (S12), and outputs the scanned image data to the image pipe 21a (S13). Here, the image data is output in the image format selected by the inter-filter adjustment. The scan filter job 111j then informs the filter framework 110 of an event (i.e., image fixed event) indicating the completion of outputting image data to the image pipe 21a (S14).

The filter framework 110 notifies the marking filter job 135j of the image fixed event received from the scan filter job 111j (S15). In response to the event notice, the marking filter job 135j retrieves image data from the image pipe 21a (S16). The marking filter job 135j causes the marking service 24 to perform a marking process (i.e., a print-person detection job or tampering detection job in the present embodiment) with respect to the image data (S17). The processing results (i.e., detection results) obtained by the marking service 24 may include image data. In such a case, the marking filter job 135j outputs the image data to the image pipe 21b (S18). In the present embodiment, the processing results obtained by the marking service 24 may include image data when the tampering detection job detects tampering. In such a case, the processing results obtained by the marking service 24 contain image data in which a mark is attached to an altered portion. The marking filter job 135j then informs the filter framework 110 of an image fixed event or a completion event indicative of process completion (when image data is not output) (S19).

The filter framework 110 notifies the print filter job 131j of the event (i.e., event indicating the completion of outputting of image data) received from the marking filter job 135j (S20). In response to the event notice, the print filter job 131j retrieves image data from the image pipe 21b (S21), and causes the printing unit 605 to print the image data (S22). After the completion of printing, the print filter job 131j notifies the filter framework 110 of a completion event (S23).

The procedure from step S12 to step S19 or to step S23 is performed on a page-by-page basis. When each filter is finished with its process with respect to all the pages, or is aborted halfway through due to some reason, a completion event is reported to the filter framework 110.

Among the processes described with reference to FIG. 31, only the processes relating to the marking filter job 135j are illustrated in FIG. 27 for the sake of convenience.

Specifically, in step S332, the filter framework 110 requests the marking filter job 135j to start a job, which corresponds to S11 in FIG. 31. When the filter framework 110 receives an image fixed event from the scan filter job 111j, the filter framework 110 notifies the marking filter job 135j of the image fixed event (S341). In response to the image fixed event, the marking filter job 135j extracts image data for one page (i.e., page image data) from image pipe 21a (S342, S343). The marking filter job 135j then requests the agent unit 2411 by using arguments indicative of the service providing condition 2414 acquired in step S331 and the page image data to perform a marking process (S344). The marking service 24 performs marking in accordance with the service providing condition 2414 (S345), and returns the execution ID to the marking filter job 135j (S346). The execution ID is an ID that is issued when the marking service 24 receives a request to perform marking, terminate marking, abort marking, and so on.

When a completion event (indicative of the completion of scanning all pages) is reported to the filter framework 110 from a filter job (i.e., the scan filter job 111j) of the filter preceding the marking filter 135 (i.e., the scan filter 111), the filter framework 110 notifies the marking filter job 135j of an event indicative of the completion of the preceding filter (i.e., a preceding filter completion event) (S351). In response to the preceding filter completion event, the marking filter job 135j requests the agent unit 2411 by using an argument indicative of the service providing condition 2414 to put an end to the marking process (S352). In response to the request, the marking service 24 performs a marking completion process in accordance with the service providing condition 2414 (S353), and returns the execution ID to the marking filter job 135j (S354).

When a completion event (e.g., indicative of a process abortion) is reported to the filter framework 131 from a filter job (i.e., the print filter job 131j) of the filter next following the marking filter 135 (i.e., the print filter 131), the filter framework 110 notifies the marking filter job 135j of an event indicative of the completion of the following filter (i.e., a following filter completion event) (S361). In response to the following filter completion event, the marking filter job 135j requests the agent unit 2411 by using an argument indicative of the service providing condition 2414 to abort the marking process (S362). In response to the request, the marking service 24 performs a marking abortion process in accordance with the service providing condition 2414 (S363), and returns the execution ID to the marking filter job 135j (S364).

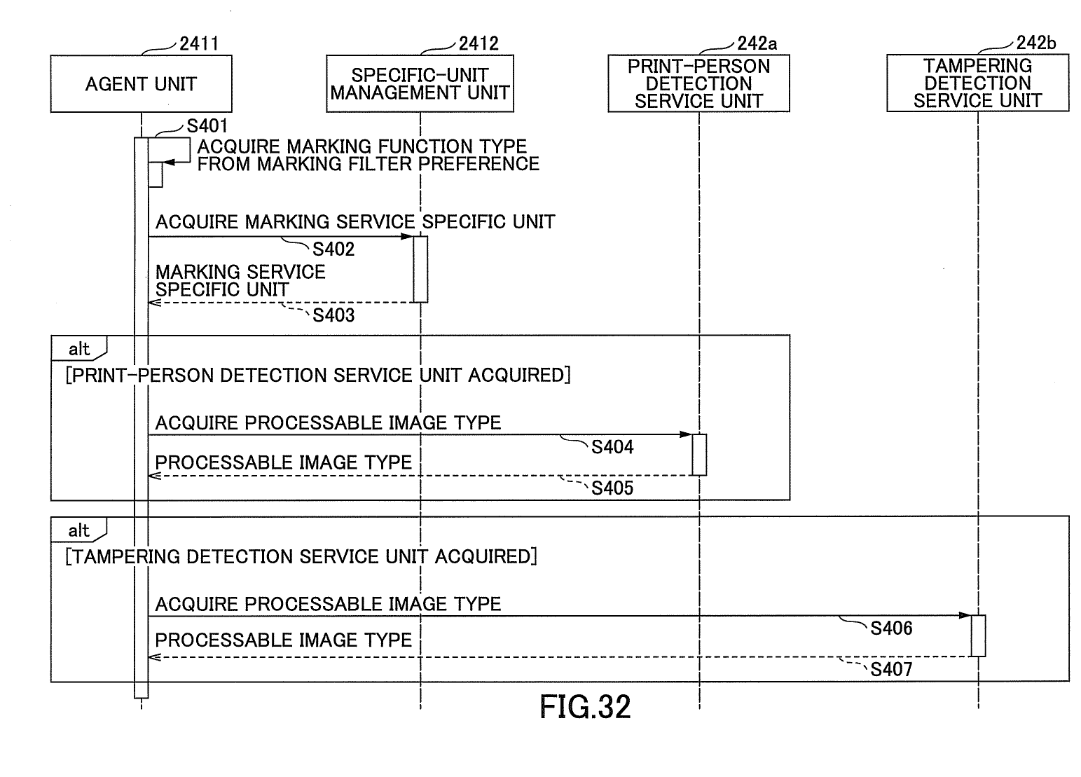

In the following, the details of step S324 will be described. FIG. 32 is a sequence chart illustrating the process of acquiring an image type processable by the marking service.

The agent unit 2411 acquires a value indicative of a marking function type from the marking filter preference 135p that is obtained as an argument in step S323 (S401). The agent unit 2411 then acquires an instance of the marking service specific unit 242 corresponding to the marking function type from the specific-unit management unit 2412 (S402, S403). The agent unit 2411 sends an inquiry together with arguments indicative of the filter name and the marking filter preference 135p obtained as arguments in step S323 to the acquired marking service specific unit 242 (i.e., print-person detection service unit 242a or tampering detection service unit 242b) to inquire about processable image types (S404 or S406). The print-person detection service unit 242a or tampering detection service unit 242b determines processable image types based on the filter name and the marking attributes stored in the marking filter preference 135p, and returns data indicative of the image types to the agent unit 2411 (S405 or S407).

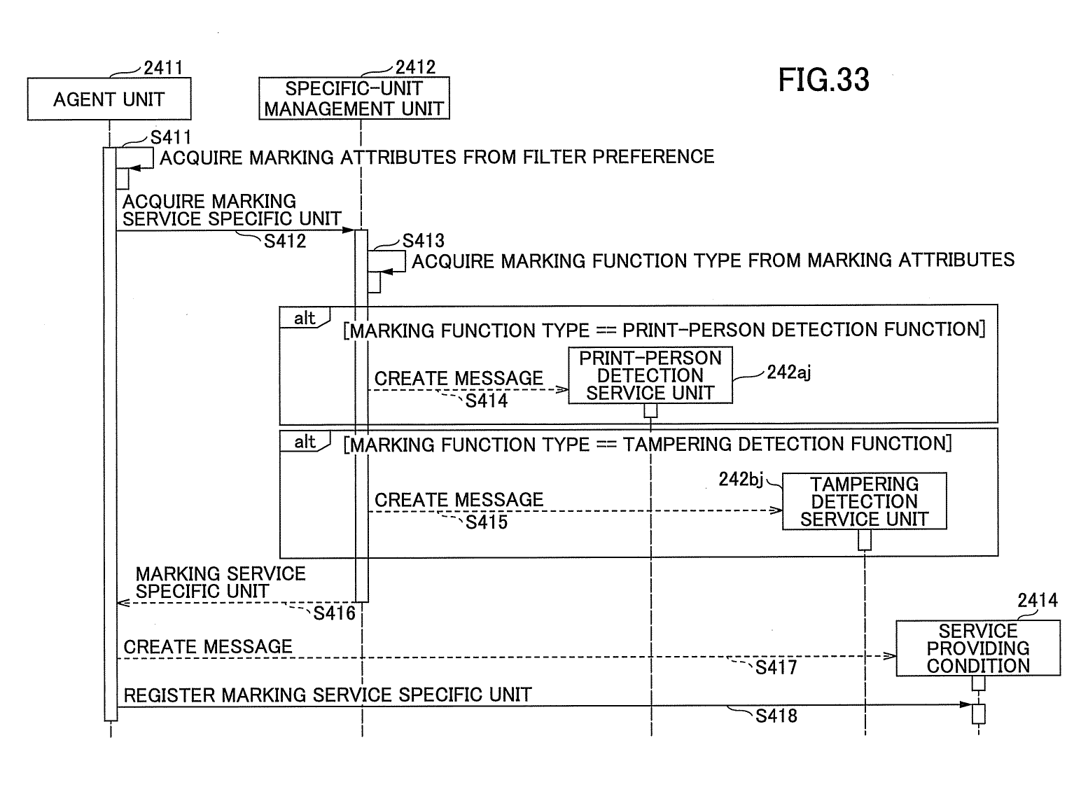

In the following, the details of step S330 shown in FIG. 27 will be described. FIG. 33 is a sequence chart illustrating the process of generating service providing conditions by the marking service.

The agent unit 2411 acquires marking attributes from the marking filter preference 135p that is obtained as an argument in step S329 (S411). The agent unit 2411 requests the specific-unit management unit 2412 by use of an argument indicative of the acquired marking attributes to generate an instance of the marking service specific unit 242 corresponding to the marking job to be executed (S412).

The instance (print-person detection service unit 242a or tampering detection service unit 242b) of the marking service specific unit 242 that appears in the sequence charts prior to FIG. 33 is a resident instance that is utilized in a shared manner by respective jobs. The instance requested to be generated in step S412, on the other hand, is specific to each job. Such instance is generated upon creation of a job, and is discarded upon completion of the job. In order to discriminate one from the other, the latter is referred by a reference numeral having “j” at the end.

The specific-unit management unit 2412 acquires a marking function type from the marking attributes (S413). When the marking function type indicates the print-person detection function, the specific-unit management unit 2412 generates an instance (i.e., object) of a print-person detection service unit 242aj (S414). In so doing, the specific-unit management unit 2412 sets the marking attributes to the print-person detection service unit 242aj. When the marking function type indicates the tampering detection function, the specific-unit management unit 2412 generates an instance (i.e., object) of a tampering detection service unit 242bj (S415). In so doing, the specific-unit management unit 2412 sets the marking attributes to the tampering detection service unit 242bj.

The specific-unit management unit 2412 then returns the generated instance (i.e., print-person detection service unit 242aj or tampering detection service unit 242bj) of the marking service specific unit 242 to the agent unit (S416). The agent unit 2411 generates an instance of the service providing condition 2414, and registers the instance of the marking service specific unit 242 generated in step S414 or S415 in the service providing condition 2414 (S418).

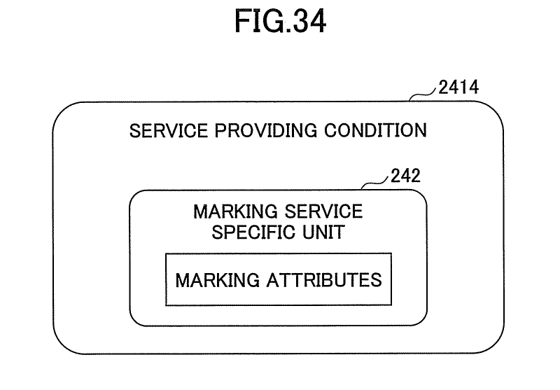

FIG. 34 is a drawing illustrating the relationships between a service providing condition, a marking service specific unit, and marking attributes. As illustrated in FIG. 34, the marking service specific unit 242 (i.e., print-person detection service unit 242aj or tampering detection service unit 242bj) to be executed is registered in the service providing condition 2414. Further, marking attributes are registered in the marking service specific unit 242. In this manner, the service providing condition 2414 contains all the information (i.e., process conditions) necessary for performing marking corresponding to a job to be performed.

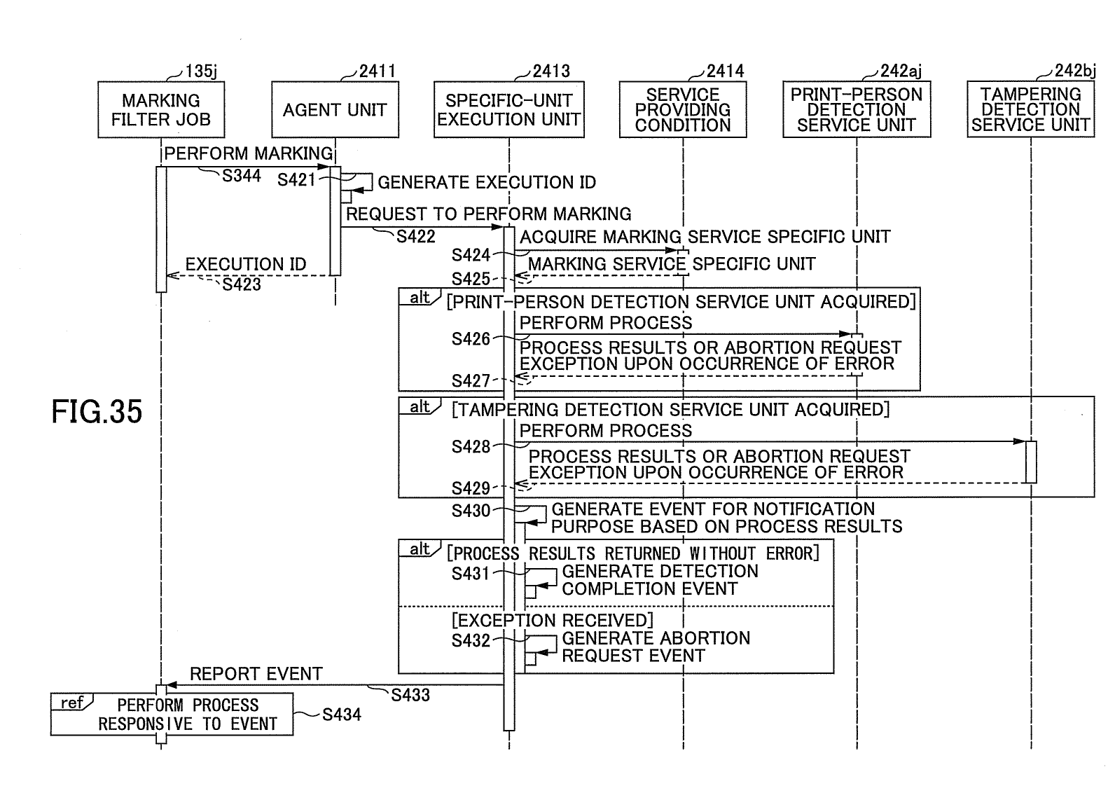

In the following, the details of step S345 shown in FIG. 27 will be described. FIG. 35 is a sequence chart illustrating marking performed by the marking service.

Upon receiving a request to execute (i.e., perform) marking from the marking filter job 135j in step S344 (FIG. 27), the agent unit 2411 generates an execution ID corresponding to the execution request (S421). The agent unit 2411 then requests the specific-unit execution unit 2413 by using arguments indicative of page image data and the service providing condition 2412 generated by the procedure of FIG. 33 to perform a marking process (S2413). After making such a request, the agent unit 2411 returns the execution ID to the marking filter job 135j (S423).

Having received the request to perform marking, the specific-unit execution unit 2413 acquires an instance of the marking service specific unit 242 registered in the service providing condition 2414 specified as an argument (S424, S425), and then inputs into the acquired instance a marking execution request with an argument indicative of a page image.

When the acquired instance is the print-person detection service unit 242aj, the execution request is input into the print-person detection service unit 242aj (S426). The print-person detection service unit 242aj performs a print-person detection process with respect to the page image based on the marking attributes set in itself, and returns the results of processing (i.e., the results of detection) to the specific-unit execution unit 2413 (S427). When the print-person detection process is properly performed, the results of detection contain information indicative of a print person (e.g., the name of a print person). When an error occurs during the print-person detection process, an exception is issued.

When the acquired instance is the tampering detection service unit 242bj, on the other hand, the execution request is input into the tampering detection service unit 242bj (S428). The tampering detection service unit 242bj performs a tampering detection process with respect to the page image based on the marking attributes set in itself, and returns the results of processing (i.e., the results of detection) to the specific-unit execution unit 2413 (S429). When the tampering detection process is properly performed, the results of detection include data indicative of the presence or absence of tampering and a page image (i.e., detection result image) having a mark attached to an altered portion in the case of the presence of tampering. When an error occurs during the tampering detection process, an exception is issued.

Thereafter, the specific-unit execution unit 2413 generates an event indicative of the results of detection (S430). When the marking process is properly performed, a detection completion event is generated (S431). When an exception is issued, an abortion request event is generated (S432). The event completion event contains the results of detection. The specific-unit execution unit 2413 notifies the marking filter job 135j of the generated event (S433) In response to the event notification, the marking filter job 135j performs a process responsive to the notified event (S434). The details of step S434 will later be described.

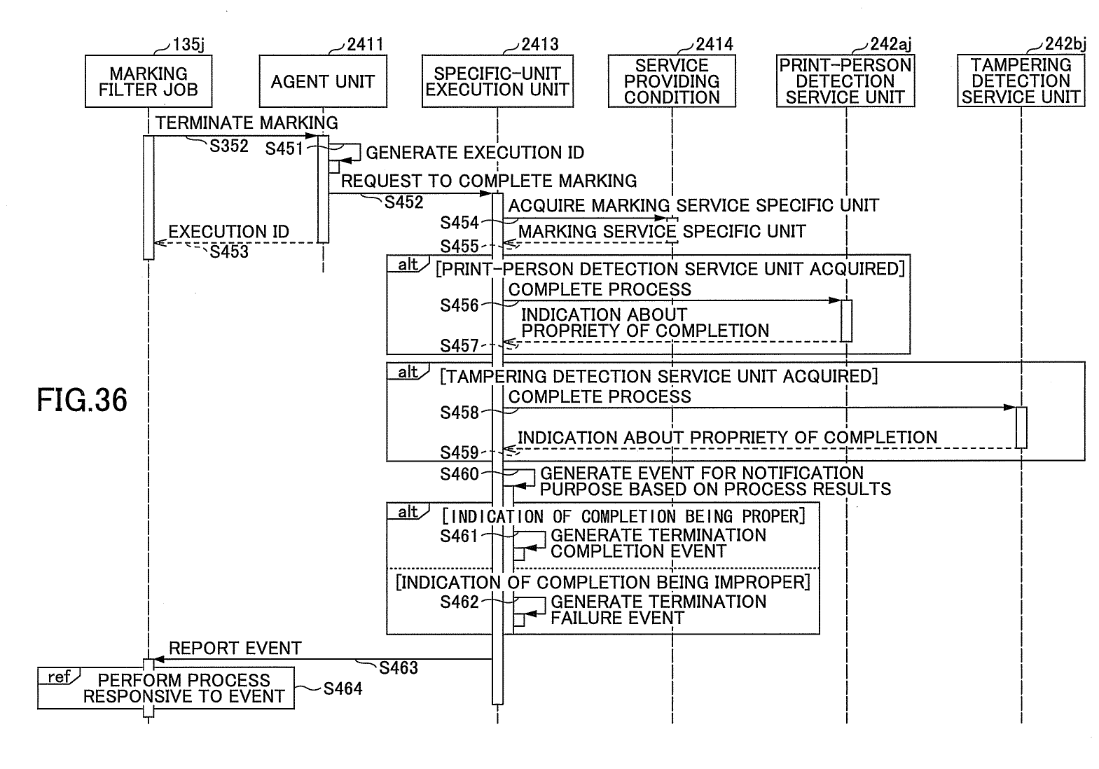

In the followings the details of step S353 shown in FIG. 27 will be described. FIG. 36 is a sequence chart illustrating the process of ending marking performed by the marking service.

Upon receiving a request to end marking from the marking filter job 135j in step S352 (FIG. 27), the agent unit 2411 generates an execution ID corresponding to the completion request (S451). The agent unit 2411 then requests the specific-unit execution unit 2413 by using an argument indicative of the service providing condition 2412 (see FIG. 34) generated by the procedure of FIG. 33 to complete (i.e., end) a marking process (S452). After making such a request, the agent unit 2411 returns the execution ID to the marking filter job 135j (S453).

Having received the request to perform marking, the specific-unit execution unit 2413 acquires an instance of the marking service specific unit 242 registered in the service providing condition 2414 specified as an argument (S454, S455), and then inputs a marking completion request into the acquired instance.

When the acquired instance is the print-person detection service unit 242aj, the completion request is input into the print-person detection service unit 242aj (S456). The print-person detection service unit 242aj checks whether to end the process based on the marking attributes set in itself and the current operation status of the print-person detection process, and puts an end to the print-person detection process if termination is proper. The print-person detection service unit 242aj returns the results of the check indicative of whether to end the process to the specific-unit execution unit 2413 (S457).

When the acquired instance is the tampering detection service unit 242bj, on the other hand, the completion request is input into the tampering detection service unit 242bj (S458). The tampering detection service unit 242bj checks whether to end the process based on the marking attributes set in itself and the current operation status of the tampering detection process, and puts an end to the tampering detection process if termination is proper. The tampering detection service unit 242bj returns the result of check indicative of whether to end the process to the specific-unit execution unit 2413 (S459).

Thereafter, the specific-unit execution unit 2413 generates an event indicative of the results of the check indicative of whether to end the process (S460). When process termination is proper, a termination completion event is generated (S461). When process termination is not proper, a termination failure event is generated (S462). The specific-unit execution unit 2413 notifies the marking filter job 135j of the generated event (S463). In response to the event notification, the marking filter job 135j performs a process responsive to the notified event (S464). The details of step S464 will later be described.

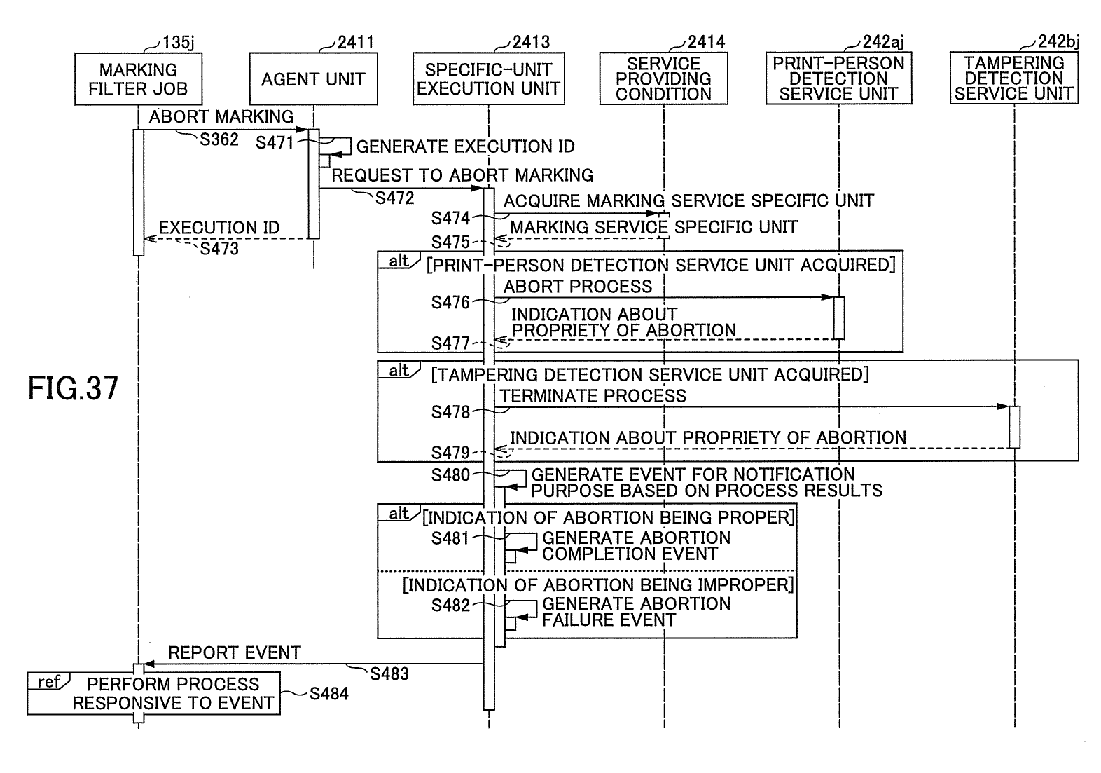

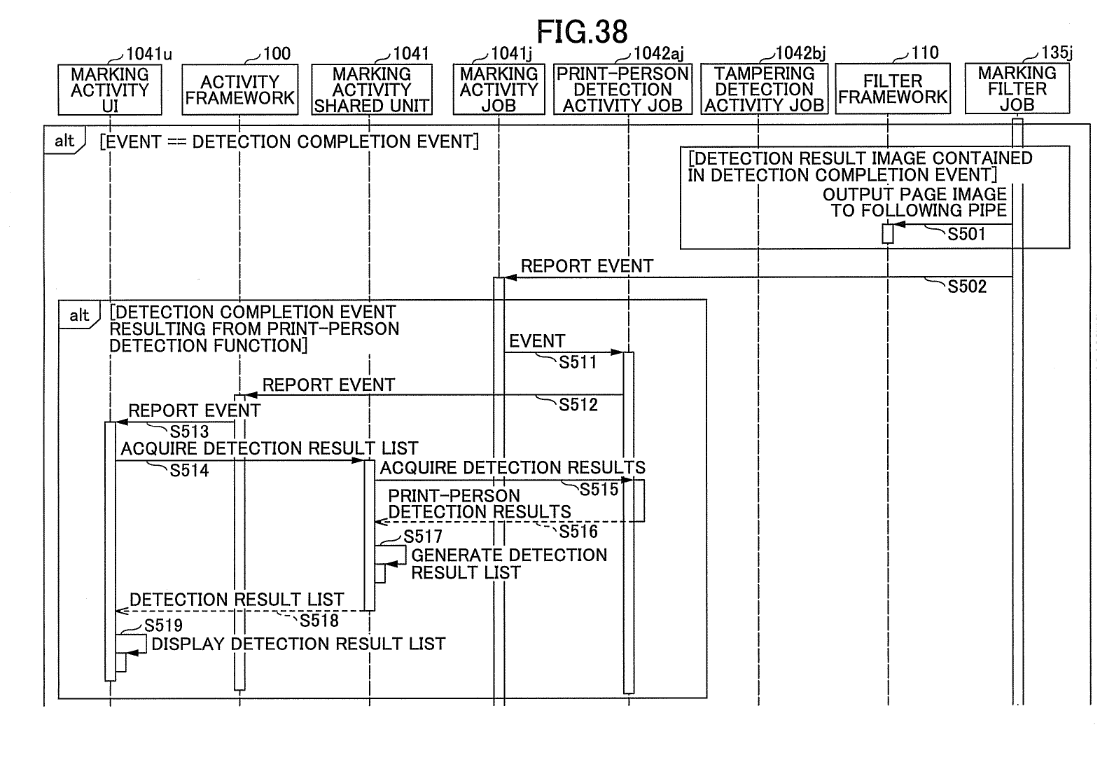

In the following, the details of step S363 shown in FIG. 27 will be described. FIG. 37 is a sequence chart illustrating the process of aborting marking performed by the marking service.

Upon receiving a request to abort marking from the marking filter job 135j in step S362 (FIG. 27), the agent unit 2411 generates an execution ID corresponding to the abortion request (S471). The agent unit 2411 then requests the specific-unit execution unit 2413 by using an argument indicative of the service providing condition 2412 (see FIG. 34) generated by the procedure of FIG. 33 to abort a marking process (S472). After making such a request, the agent unit 2411 returns the execution ID to the marking filter job 135j (S473).

Having received the request to perform marking, the specific-unit execution unit 2413 acquires an instance of the marking service specific unit 242 registered in the service providing condition 2414 specified as an argument (S474, S475), and then inputs a marking abortion request into the acquired instance.

When the acquired instance is the print-person detection service unit 242aj, the abortion request is input into the print-person detection service unit 242aj (S476). The print-person detection service unit 242aj checks whether to abort the process based on the marking attributes set in itself and the current operation status of the print-person detection process, and aborts the print-person detection process if abortion is proper. The print-person detection service unit 242aj returns the results of the check indicative of whether to abort the process to the specific-unit execution unit 2413 (S477).

When the acquired instance is the tampering detection service unit 242bj, on the other hand, the abortion request is input into the tampering detection service unit 242bj (S478). The tampering detection service unit 242bj checks whether to abort the process based on the marking attributes set in itself and the current operation status of the tampering detection process, and aborts the tampering detection process if abortion is proper. The tampering detection service unit 242bj returns the results of the check indicative of whether to abort the process to the specific-unit execution unit 2413 (S479).

Thereafter, the specific-unit execution unit 2413 generates an event indicative of the results of the check indicative of whether to abort the process (S480). When process abortion is proper, an abortion completion event is generated (S481). When process abortion is not proper, an abortion failure event is generated (S482). The specific-unit execution unit 2413 notifies the marking filter job 135j of the generated event (S483). In response to the event notification, the marking filter job 135j performs a process responsive to the notified event (S484). The details of step S484 will later be described.

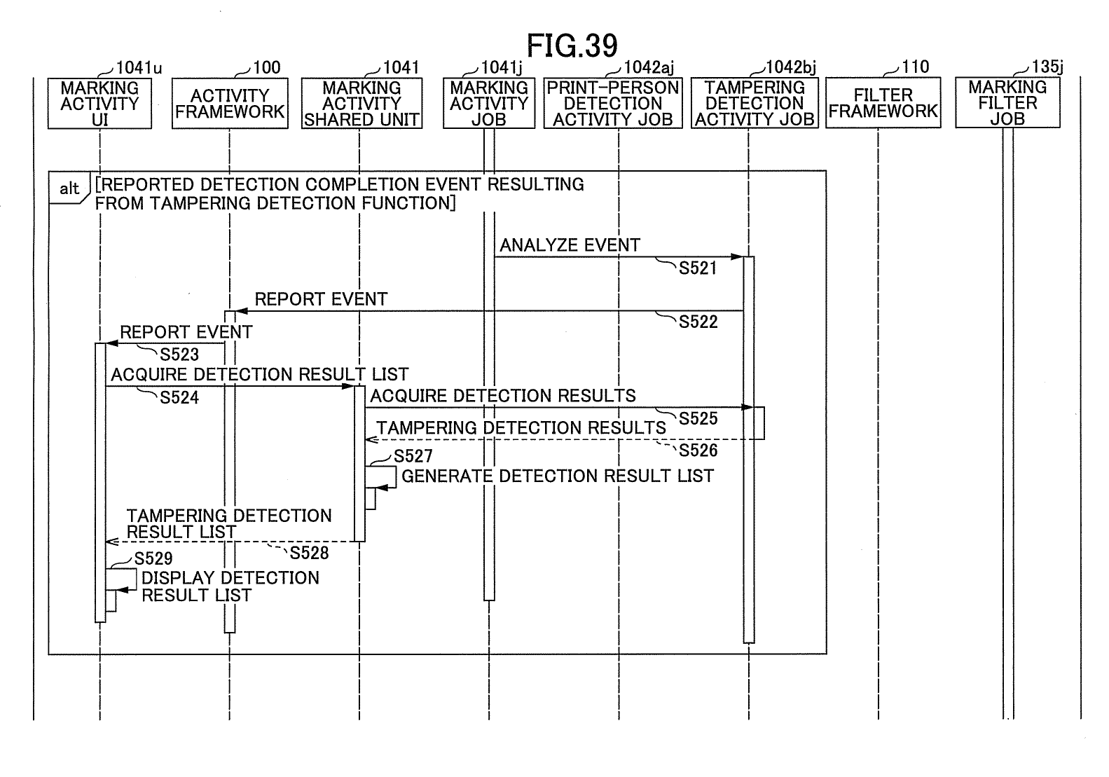

In the following, the details of step S434 (FIG. 35) will be described. FIGS. 38 and 39 are sequence diagrams illustrating processes performed when a detection completion event is reported from the marking service.

When the event reported from the marking service 24 is a detection completion event, the marking filter job 135j checks whether the detection completion event contains a detection result image (i.e., image data having a mark attached to an altered portion). If the detection result image is contained in the detection completion event, the marking filter job 135j outputs the detection result image to the image pipe 21b (see FIG. 31) (S501). The marking filter job 135j notifies the marking activity job 1041j of the detection completion event (S502).

The marking activity then reports the detection completion event to the object of the marking activity specific unit 1042 that is set in itself in step S308 of FIG. 26.

When the detection completion event contains the results of detection of the print-person detection function, the detection completion event is reported to the print-person detection activity job 1042aj (S511). The print-person detection activity job 1042aj notifies the activity framework 100 of the detection completion event (S512). The activity framework 100 notifies the marking activity UI 1041u of the detection completion event (S513).

The marking activity UI 1041u then requests the marking activity shared unit 1041 to provide data containing a list of detection results (hereinafter referred to as a “detection result list”) (S514). In response to the request, the marking activity shared unit 1041 requests the print-person detection activity job 1042aj to provide the results of detection (S515). The print-person detection activity job 1042aj analyzes the detection completion event to extract the detection results (i.e., print-person detection results), and returns the print-person detection results to the marking activity shared unit 1041 (S516). The print-person detection results contain identification information indicative of a print person (e.g., the name of a print person). The marking activity shared unit 1041 generates a print-person detection result list based on the print-person detection results (S517), and returns the detection result list to the marking activity UI 1041u (S518). The marking activity UI 1041u causes the operation panel 602 to display a screen (i.e., print-person detection result screen) for displaying the print-person detection result list (S519).

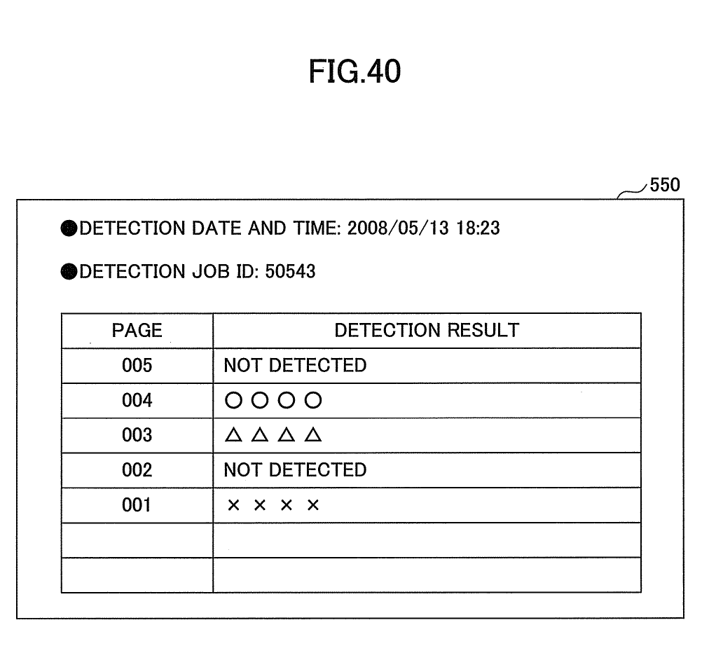

FIG. 40 is a drawing illustrating an example of the print-person detection result screen. As illustrated in FIG. 40, a print-person detection result screen 550 displays identification information indicative of a print person on a page-specific basis, such as “OOOO”, “ΔΔΔΔ”, and “XXXX”. As for pages for which no print person is detected, a message indicative of no detection is displayed.

When the detection completion event contains the results of detection of the tampering detection function, the detection completion event is reported to the tampering detection activity job 1042bj (FIG. 39: S521). The tampering detection activity job 1042bj notifies the activity framework 100 of the detection completion event (S522). The activity framework 100 notifies the marking activity UI 1041u of the detection completion event (S523).

The marking activity UI 1041u then requests the marking activity shared unit 1041 to provide a detection result list (S524). In response to the request, the marking activity shared unit 1041 requests the tampering detection activity job 1042bj to provide the results of detection (S525). The tampering detection activity job 1042bj analyzes the detection completion event to extract the detection results (i.e., tampering detection results), and returns the tampering detection results to the marking activity shared unit 1041 (S526). The tampering detection results indicate the presence or absence of tampering. The marking activity shared unit 1041 generates a tampering detection result list based on the tampering detection results (S527), and returns the detection result list to the marking activity UI 1041u (S528). The marking activity UI 1041u causes the operation panel 602 to display a screen (i.e., tampering detection result screen) for displaying the tampering detection result list (S529).

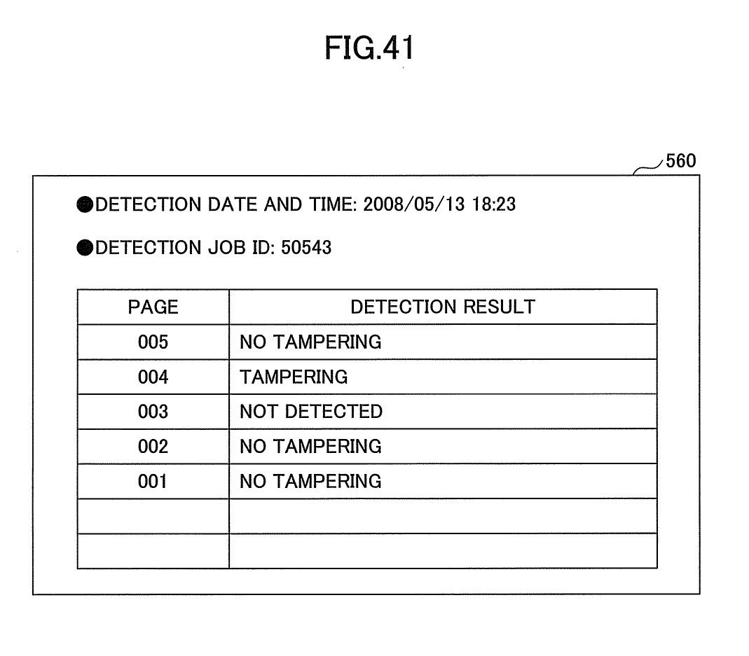

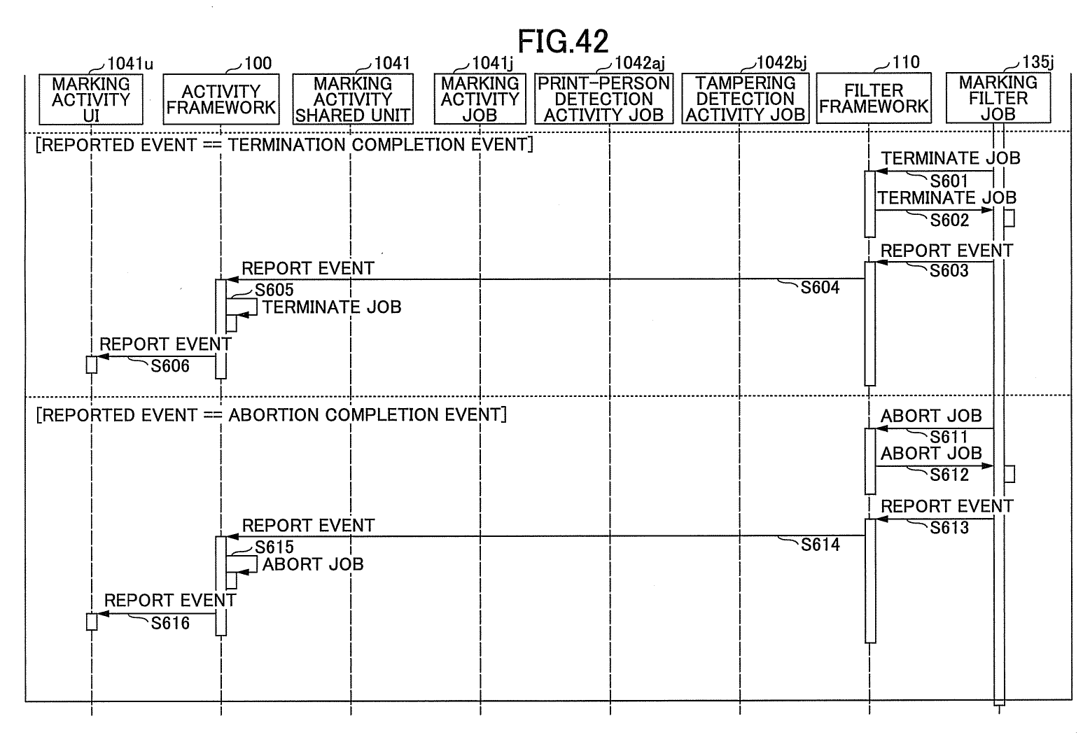

FIG. 41 is a drawing showing an example of the tampering detection setting screen. As illustrated in FIG. 41, a tampering detection result screen 560 displays a message indicative of the presence or absence of tampering on a page-specific basis. As for pages for which the presence or absence of tampering is not detected, a message indicative of no detection is displayed.

In the following, the details of step S464 (FIG. 36) or step S484 (FIG. 37) will be described. FIG. 42 is a sequence diagram illustrating processes performed when a termination completion event or abortion completion event is reported from the marking service.

When the event reported from the marking service 24 is a termination completion event, the marking filter job 135j notifies the filter framework 110 of a job completion (S601). The filter framework 110 reports the job completion to each filter's job object utilized in the marking job. In FIG. 42, the job completion is reported only to the marking filter job 135j for the sake of convenience of illustration (S602).

Thereafter, the marking filter job 135j notifies the filter framework 110 of the termination completion event (S603). The filter framework 110 then notifies the activity framework 100 of the termination completion event (S604). The activity framework 100 performs a job completion process (S605), and notifies the marking activity UI 1041u of the termination completion event (S606). In response to the termination completion event, the marking activity UI 1041u changes the status of the display screen to the one in which a job is completed.

When the event reported from the marking service 24 is an abortion completion event, on the other hand, the marking filter job 135j notifies the filter framework 110 of a job abortion (S611). The filter framework 110 reports the job abortion to each filter's job object utilized in the marking job. In FIG. 42, the job abortion is reported only to the marking filter job 135j for the sake of convenience of illustration (S612).

Thereafter, the marking filter job 135j notifies the filter framework 110 of the abortion completion event (S613). The filter framework 110 then notifies the activity framework 100 of the abortion completion event (S614). The activity framework 100 performs a job abortion process (S615), and notifies the marking activity UI 1041u of the abortion completion event (S616). In response to the abortion completion event, the marking activity UI 1041u changes the status of the display screen to the one in which a job is aborted.

Among all the processes performed in the marking job procedure, only the processes relating to the print-person detection activity job 1042aj and the tampering detection activity job 1042bj in FIG. 26, FIG. 27, FIG. 38, FIG. 39, and FIG. 42 may need to be implemented as a portion specific to each marking function. Further, only the processes relating to the print-person detection service unit 242a (242aj) and the tampering detection service unit 242b (242bj) in FIG. 32, FIG. 33, FIG. 35, FIG. 36, and FIG. 37 may need to be implemented as a portion specific to each marking function. If the multifunctional machine 1 is not provided with the marking framework, the processes relating to the marking activity shared unit 1041, the marking activity job 1041j, the marking activity preference 1041p, the marking filter 135, and the marking filter job 135j in FIG. 26, FIG. 27, FIG. 38, FIG. 39, and FIG. 42 may also need to be implemented as a portion specific to each marking function. In FIG. 32, FIG. 33, FIG. 35, FIG. 36, and FIG. 37, the processes relating to the agent unit 2411 and the specific-unit management unit 2412 may also need to be implemented as a portion specific to each marking function.

In this manner, the provision of the marking framework significantly reduces the portions that need to be implemented specifically for each marking function in the implementation of a marking job execution procedure.

As described above, the multifunctional machine 1 according to the present embodiment uses a marking framework to control processes relating to relationships between an activity and a filter, relationships between filters, relationships between a filter and a service mechanism 20, and so on with respect to the marking functions. When a new marking function is to be added, therefore, all that may be needed is to create a new marking activity specific unit 1042 by implementing an interface (i.e., function or method) defined in the marking activity shared unit 1041 and to create a new marking service specific unit 242 by implementing an interface (i.e., specific-unit interface 2415) defined in the marking service shared unit 241. Namely, all that may be required of a person who develops a marking function is to implement a function or method that is predefined, without being conscious of its relationships with other components. Accordingly, a person who has no in-depth knowledge of the entire specifications of the software architecture of the multifunctional machine 1 can still implement a new marking function.

The present embodiment has been described with respect to a procedure for the extraction of information (as in the print-person detection function and the tampering detection function) among various marking functions. The embedding of information (as in the print-person detection information embedding function and the tampering detection information embedding function) may also be implemented similarly on the marking framework. When the print-person detection information embedding function is to be added, a print-person detection information embedding activity unit may be implemented as a marking activity specific unit, and a print-person detection information embedding service unit may be implemented as a marking service specific unit 242. The print-person detection information embedding activity unit may be configured to perform similar processes to those of the print-person detection activity unit 1042a. Further, the print-person detection information embedding service unit may be configured to embed, into a page image supplied as a process object, identification information indicative of a print person (e.g., the user name of a user who is currently logged in on the multifunctional machine 1) by use of a background pattern, a barcode, or the like. The same applies in the case of the tampering detection information embedding function.

The present embodiment has been described with respect to an example in which the components in the three layers, i.e., the marking activity 104, the marking filter 135, and the marking service 24, are all implemented as a framework (see FIG. 8 and FIG. 9). Provision may be made such that either one of the marking activity 104 and the marking service 24 is implemented without using a framework. Such configuration may still improve the customizability of marking functions.

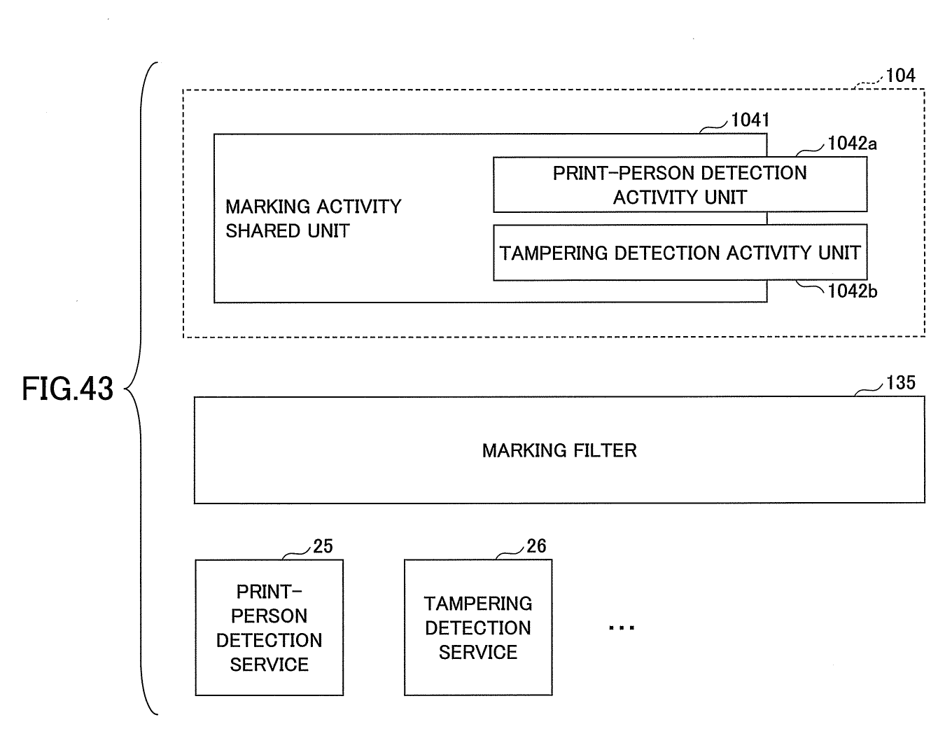

FIG. 43 is a drawing illustrating an example of a configuration in which a marking framework does not have a marking service shared unit. In FIG. 43, the same elements as those of FIG. 9 are referred to by the same numerals.

When the marking service shared unit 241 is not included in the marking framework, a marking service 24 needs to be created separately for each marking function. In FIG. 43, a print-person detection service 25 and a tampering detection service 26 are illustrated as an example of a marking service 24 that is created separately for each marking function. In this case, the processes performed by the marking service shared unit 241 (i.e., processes performed by the agent unit 2411, the specific-unit management unit 2412, and the specific-unit execution unit 2413 in the sequence charts) may need to be implemented in each of the print-person detection service 25 and the tampering detection service 26. The task of creating the marking service 24 may thus become more complex than in the case of the configuration illustrated in FIG. 9. Since only the marking activity specific unit 1042 may be implemented for the marking activity 104, customizability may be improved.

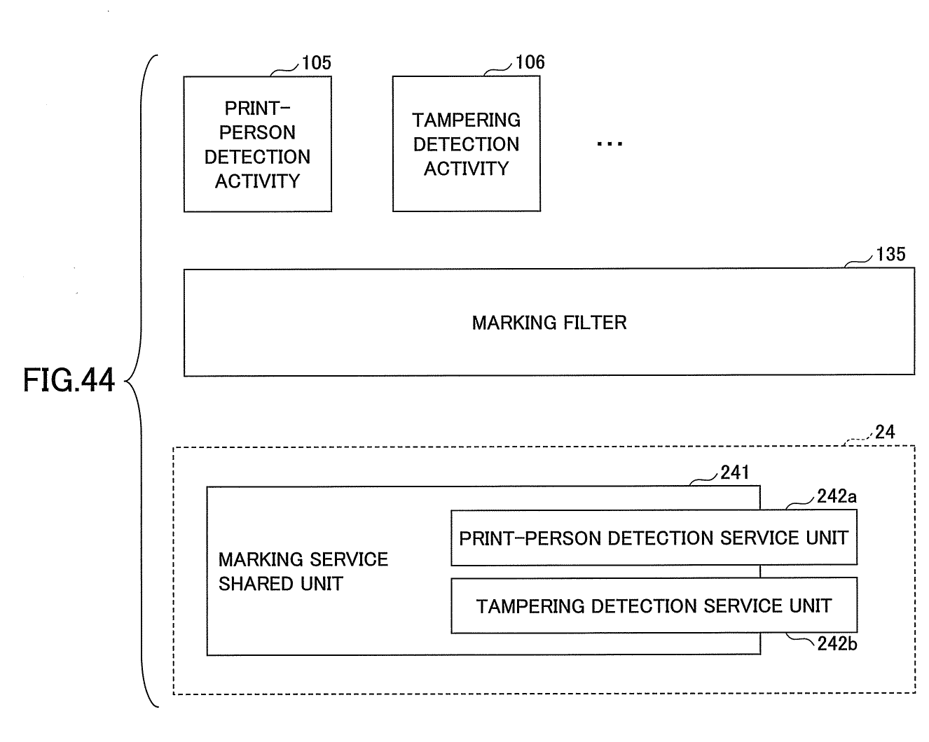

FIG. 44 is a drawing illustrating an example of a configuration in which a marking framework does not have a marking activity shared unit. In FIG. 44, the same elements as those of FIG. 9 are referred to by the same numerals.

When the marking activity shared unit 1041 is not included in the marking framework, a marking activity 104 needs to be created separately for each marking function. In FIG. 44, a print-person detection activity 105 and a tampering detection activity 106 are illustrated as an example of a marking activity 104 that is created separately for each marking function. In this case, the processes performed by the marking activity shared unit 1041 (i.e., processes performed by the marking activity shared unit 1041, the marking activity preference 1041p, and the marking activity job 1041j in the sequence charts) may need to be implemented in each of the print-person detection activity 105 and the tampering detection activity 106. The task of creating the marking activity 104 may thus become more complex than in the case of the configuration illustrated in FIG. 9. Since only the marking service specific unit 242 may be implemented for the marking service 24, customizability may be improved.

Further, the present invention is not limited to these embodiments, but various variations and modifications may be made without departing from the scope of the present invention.

The present application is based on Japanese priority application No. 2008-238629 filed on Sep. 17, 2008, with the Japanese Patent Office, the entire contents of which are hereby incorporated by reference.

What is claimed is:

1. An image forming apparatus for performing a job relating to image data, to which software components are connected to perform processes constituting respective parts of the job, comprising:
an embed-information processing control unit configured to control, based on a first one of the software components, embed-information processing for extracting embedded information or for embedding information with respect to image data output from a second one of the software components; and
an embed-information processing service unit configured to perform the embed-information processing with respect to the image data in response to an instruction from the embed-information processing control unit,
wherein the embed-information processing service unit includes a shared service unit configured to perform a process shared by different types of the embed-information processing, and one or more specific service units each configured to perform a different process specific to a different type of the embed-information processing,
and wherein the shared service unit is configured to receive an instruction from the embed-information processing control unit, and the specific service units are configured to perform the embed-information processing with respect to the image data.

2. The image forming apparatus as claimed in claim 1, wherein the embed-information processing control unit is configured to inquire of the shared service unit about configurations of setting items to be set by a user with respect to given embed-information processing, and the shared service unit is configured to cause one of the specific service units corresponding to a type of the given embed-information processing to respond to the inquiry.

3. The image forming apparatus as claimed in claim 2, wherein the embed-information processing control unit is configured to inquire of the shared service unit about initial values of setting items to be set by a user with respect to the given embed-information processing, and the shared service unit is configured to cause one of the specific service units corresponding to the type of the given embed-information processing to respond to the inquiry.

4. The image forming apparatus as claimed in claim 1, wherein the embed-information processing control unit is configured to inquire of the shared service unit about a type of image data processable by the embed-information processing service unit, and to check whether the image data output from said second one of the software components is processable based on a response obtained in response to the inquiry about the type of image data, and the shared service unit is configured to inquire of one of the specific service units about a type of processable image data in response to the inquiry about the type of image data.

5. The image forming apparatus as claimed in claim 1, further comprising an embed-information job control unit configured to control an embed-information job for extracting embedded information or for embedding information with respect to image data by connecting the software components,
and wherein the embed-information job control unit includes a shared unit configured to perform a process shared by different types of embed-information jobs, and one or more specific units each configured to perform a different process specific to a different type of an embed-information job,
and wherein the specific units are configured to generate connect relationships between the software components in response to types of embed-information jobs.

6. A computer-readable medium having a program embodied therein for use in an image forming apparatus for performing a job relating to image data, to which software components are connected to perform processes constituting respective parts of the job, said program causing the information forming apparatus to function as:
an embed-information processing control unit configured to control, based on a first one of the software components, embed-information processing for extracting embedded information or for embedding information with respect to image data output from a second one of the software components; and
an embed-information processing service unit configured to perform the embed-information processing with respect to the image data in response to an instruction from the embed-information processing control unit,
wherein the embed-information processing service unit includes a shared service unit configured to perform a process shared by different types of the embed-information processing, and one or more specific service units each configured to perform a different process specific to a different type of the embed-information processing, and wherein the shared service unit is configured to receive an instruction from the embed-information processing control unit, and the specific service units are configured to perform the embed-information processing with respect to the image data.

7. The computer-readable medium as claimed in claim 6, wherein the embed-information processing control unit is configured to inquire of the shared service unit about configurations of setting items to be set by a user with respect to the given embed-information processing, and the shared service unit is configured to cause one of the specific service units corresponding to the type of the given embed-information processing to respond to the inquiry.

8. The computer-readable medium as claimed in claim 7, wherein the embed-information processing control unit is configured to inquire of the shared service unit about initial values of setting items to be set by a user with respect to given embed-information processing, and the shared service unit is configured to cause one of the specific service units corresponding to a type of the given embed-information processing to respond to the inquiry.

9. The computer-readable medium as claimed in claim 6, wherein the embed-information processing control unit is configured to inquire of the shared service unit about a type of image data processable by the embed-information processing service unit, and to check whether the image data output from said second one of the software components is processable based on a response obtained in response to the inquiry about the type of image data, and the shared service unit is configured to inquire of one of the specific service units about a type of processable image data in response to the inquiry about the type of image data.

10. The computer-readable medium as claimed in claim 6, wherein said program further includes an embed-information job control unit configured to control an embed-information job for extracting embedded information or for embedding information with respect to image data by connecting the software components, and
wherein the embed-information job control unit includes a shared unit configured to perform a process shared by different types of embed-information jobs, and one or more specific units each configured to perform a different process specific to a different type of an embed-information job,
and wherein the specific units are configured to generate connect relationships between the software components in response to types of embed-information jobs.

11. A method of performing a job relating to image data in an image forming apparatus to which software components are connected to perform processes constituting respective parts of the job, comprising:
controlling, based on a first one of the software components, embed-information processing for extracting embedded information or for embedding information with respect to image data output from a second one of the software components; and
performing the embed-information processing with respect to the image data in response to an instruction from the step of controlling,
wherein the step of performing includes utilizing a shared service unit configured to perform a process shared by different types of the embed-information processing, and utilizing one or more specific service units each configured to perform a different process specific to a different type of the embed-information processing,
and wherein the shared service unit is configured to receive an instruction from the embed-information processing control unit, and the specific service units are configured to perform the embed-information processing with respect to the image data.

12. The method as claimed in claim 11, wherein the step of controlling includes inquiring of the shared service unit about configurations of setting items to be set by a user with respect to given embed-information processing, and the shared service unit is configured to cause one of the specific service units corresponding to a type of the given embed-information processing to respond to the inquiry.

13. The method as claimed in claim 12, wherein the step of controlling includes inquiring of the shared service unit about initial values of setting items to be set by a user with respect to the given embed-information processing, and the shared service unit is configured to cause one of the specific service units corresponding to the type of the given embed-information processing to respond to the inquiry.

14. The method as claimed in claim 11, wherein the step of controlling includes inquiring of the shared service unit about a type of image data processable by the step of performing, and to check whether the image data output from said second one of the software components is processable based on a response obtained in response to the inquiry about the type of image data, and the shared service unit is configured to inquire of one of the specific service units about a type of processable image data in response to the inquiry about the type of image data.

15. The method as claimed in claim 11, further comprising a step of controlling an embed-information job for extracting embedded information or for embedding information with respect to image data by connecting the software components,
and wherein the step of controlling the embed-information job includes utilizing a shared unit configured to perform a process shared by different types of embed-information jobs, and utilizing one or more specific units each configured to perform a different process specific to a different type of an embed-information job,
and wherein the specific units are configured to generate connect relationships between the software components in response to types of embed-information jobs.
